(19) United States
(12) Patent Application Publication
(10) Pub. No.: US 2013/0018777 A1
(43) Pub. Date: Jan. 17, 2013

(54) SYSTEMS, METHODS AND APPARATUS FOR SOCIAL NETWORK-BASED LENDING

(71) Applicant: Candace S. Klein, Cincinnati, OH (US)

(72) Inventor: Candace S. Klein, Cincinnati, OH (US)

(21) Appl. No.: 13/545,477

(22) Filed: Jul. 10, 2012

Related U.S. Application Data
(60) Provisional application No. 61/506,200, filed on Jul. 11, 2011.
(60) Provisional application No. 61/640,284, filed on Apr. 30, 2012.

(51) Int. Cl. G06Q 40/02

(52) U.S. Cl. 705/38

(57) ABSTRACT

Systems, methods and apparatus for lending are disclosed that match borrowers with potential lenders. Social media is utilized to disseminate information about lending opportunities to members of a borrower's social network or lender's social network.

### CROSS-REFERENCE TO RELATED APPLICATIONS

This application claims the benefit under Title 35, United States Code §119(e), of (1) U.S. Provisional Patent Application Ser. No. 61/506,200, entitled “SOCIAL NETWORK BASED LENDING SYSTEM”, filed on Jul. 11, 2011 and (2) U.S. Provisional Patent Application Ser. No. 61/640,284, entitled “SYSTEMS AND METHODS FOR SOCIAL NETWORK-BASED LENDING”, filed on Apr. 30, 2012, both of which are hereby incorporated by reference in their entirety.

### TECHNICAL FIELD

The systems and methods described below relate generally to the field of lending. More particularly, the systems and methods relate to matching local businesses with lenders to assist businesses in a particular geographic area or industry to help develop a particular kind of business or industry.

### BACKGROUND

Internet based peer-to-peer (“P2P”) lending web sites are a relatively new phenomenon. Various peer-to-peer lending sites attract a number of different potential lenders and a number of different borrowers and can attempt to match lenders and borrowers. Peer-to-peer lending sites play differing roles in subsequent loans and manage various aspects of the process. For example, some sites are involved as an actual lender while others are not involved in the actual funding of loans. Another area of growth on the internet is the promulgation of social networks, where individuals can electronically associate with other individuals and exchange ideas and information about common goals and areas of interest, for example.

### BRIEF DESCRIPTION OF THE DRAWINGS

The present disclosure will be more readily understood from a detailed description of some example embodiments taken in conjunction with the following figures:

FIG. 1 is a system block diagram of a system that matches businesses with potential lenders and utilizes social media.

FIG. 2 is a flow diagram of an example operation of the system for a borrower.

FIG. 3 is a flow diagram of an example operation of the system for a lender.

FIG. 4 is a flow diagram of an example operation of the system for facilitating transactions between the borrowers and lenders of FIGS. 2 and 3.

FIG. 5 is a system block diagram of a borrower registration process of a system for creating lending opportunities between lenders and borrowers.

FIG. 6 is a system block diagram of a group of administrative processes of the system for creating lending opportunities between lenders and borrowers.

FIG. 7 is a system block diagram of processes relating to borrowers including project creation and loan requests, social media communications with lenders, and evaluation of loan offers from lenders.

FIG. 8 is a system block diagram of processes relating to lenders including searches of borrower projects and associated loan requests, social media communications with borrowers, and loan offers to borrowers.

FIG. 9 is a system block diagram of processes relating to title companies including the formalization of loan agreements, automated clearing house transfers, and funding of accounts.

FIG. 10 is a system block diagram of data structures relating to borrower information, projects, and listings.

FIG. 11 is a system block diagram of data structures relating to credit information, loan analysis and approval, bank account and financial transaction information, message communications between parties.

FIG. 12 is a system block diagram of a data structure relating to search criteria for identifying potential lending opportunities.

### DETAILED DESCRIPTION

Various non-limiting embodiments of the present disclosure will now be described to provide an overall understanding of the principles of the structure, function, and use of the lending systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

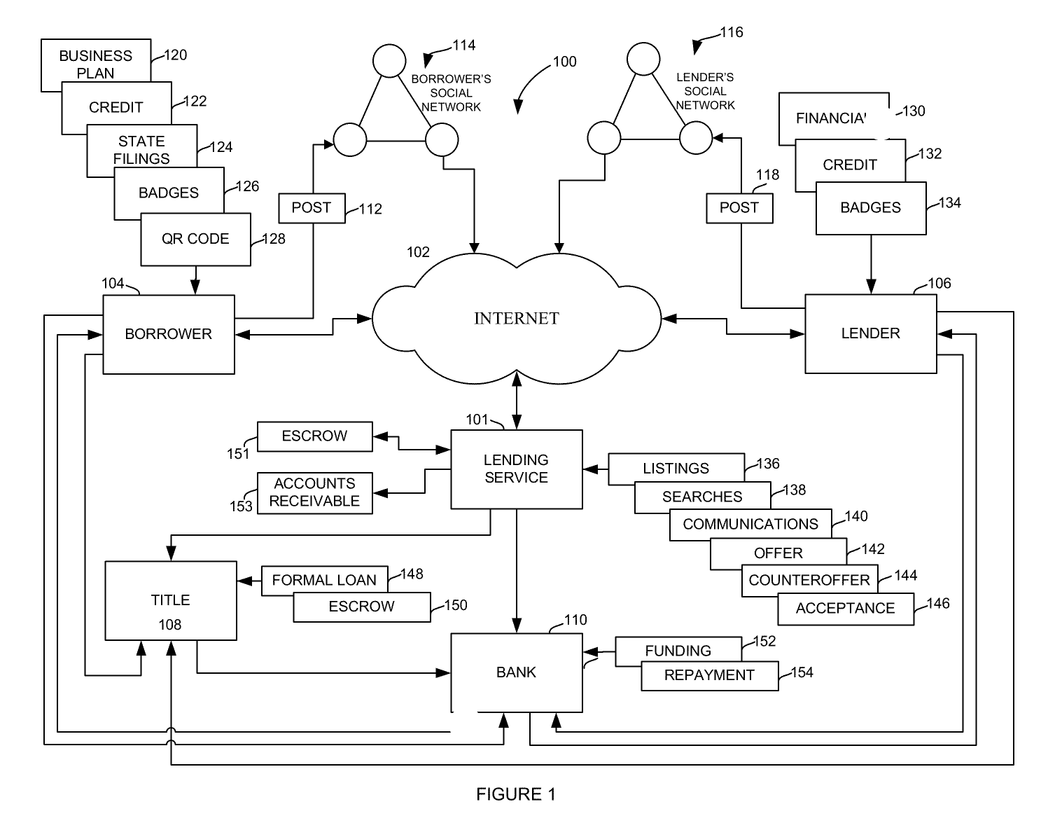

FIG. 1 is a system block diagram of a system 100 to match businesses with potential lenders and utilize social media to disseminate information about lending opportunities to members of a borrower's 104, or a lender's 106, social network 114, 116.

A borrower 104 can borrow capital from a lender 106 facilitated by a lending service 101, for example using a series of transactions and communications over a public or private data network, such as the Internet 102. A borrower 104 can provide the lending service 101 with information such as business plans 120, credit information 122 such as credit scores from credit agencies, and state filings 124, for example business filings with a secretary of state. The borrower 104 can also have badges 126 associated with their business. Badges 126, 134 can be distinctions awarded by the lending service 101 for certain events conducted with the lending service 101, for example previously repaid loans, a series of timely repayments of borrowed capital, or other transactions with the lending service 101 that the lending service 101 can use to rank borrowers 104 or lenders 106.

The borrower 104 can also have a quick response (“QR”) code 128, or other code that can be used to direct individuals to a website, such as a website for the lending service 101. The QR code 128 can encodes a weblink, such as a uniform resource locator (“URL”), to direct individuals to a webpage that displays information about the borrower 104, the borrower's 104 loan requests, or loans available through a sponsored lender 106. The borrower 104 can display the QR code 128 at their place of business, on marketing literature, or using other media. The borrower 104 can also use social media to display an informational post 112 to members of the borrower's social network 114. The post 112 can contain a QR code 128 or a link to the lending service 101 as described above. Social media can be used to spread information about the borrower 104, loan subscriptions associated with the borrower 104, or information about a sponsored lender 106.

A lender 106 can lend capital to a borrower 104 using the lending service 101, for example using a series of transactions and communications over the Internet 102. The capital lent by the lender 106 can be in a wide variety of products or vehicles, such as an installment loan, a line of credit, an interest-only loan, a balloon loan, an amortized loan, a partially amortized loan, a secured loan, an unsecured loan, and so forth. A lender 106 can provide the lending service 101 with information such as financial information 130, for example the amount of capital the lender 106 wants to lend, credit information such as credit scores from credit agencies, and lender badges 134 that the lending service 101 can use to rank lenders 106. The lender 106 can use social media to display a post 118 to the lender's social network 116 about a borrower 104, other borrowers 104 that the lenders 106 is funding, or about the lender 106.

A lending service 101 can match borrowers 104 with lenders 106. A lending service 101 can be an application running on a computing device having a processor, memory, and computer instructions, other types of computing systems, a web-based service running on a server, or a distributed process running on multiple servers or computers in a network, for example a network cloud, the Internet 102, a local network, or other kind of communications links or networks. The lending service 101 can display listings 136 of the borrowers 104 to lenders 106. Lenders 106 can perform searches 138 of the listings 136 to find borrowers 104 that fit the loan criteria of the lenders 106. A listing 136 can include information from the borrower 104 and can include information provided by the lending service 101. A lending service 101 can use information from the borrower 104 to create portions of the listing 136. Information from the borrower 104 can include, but is not limited to, business plans 120, credit information 122, state filings 124, and badges 126. The lending service 101 can use the information to create a ranking for the borrower 104, determine a limit of the amount of capital that the borrower 104 can borrow, determine the allowable length of the loan, and establish ranges of interest rates for prospective lenders 106. Other information can include, for example current lending rates, such as the LIBOR or Prime Rates, or risk related to the kind of borrower 104, or borrower's 104 business or industry.

The ranking for the borrower 104, can be presented or otherwise formulated using any number of suitable formats. For example, the ranking may be presented as a borrower score (such as 4.3 out of 10, for example), a star system (such as 3 out of 4 stars, for example), or any other suitable demarcation or identification, such as a “platinum” borrower, for example. In any event, the ranking may generally be a sliding scale, with various lending parameters changing across the scale. A borrower at the top end of the scale may enjoy lower interest rates and a high lending cap than a borrower positioned towards the bottom end of the scale, for example. The lending service 101 can use an underwriting process to assign a ranking to the borrower 104. In some embodiments, the ranking of the borrower 104 may be directly conveyed to the borrower 104 but not directly conveyed to the lender 106. Instead, as discussed in more detail below, the ranking of the borrower 104 may be utilized when the lender 106 is searching for borrowers. The ranking of the borrower 104 may also inform the loan parameters presented to a lender 106 associated with a particular borrower 104. For example, a listing associated with a borrower that has been identified as a “4 star” borrower may indicate that the interest rate for a loan to that borrower must be in the range of 10% to 12%. By comparison, a listing associated with a borrower that has been identified as a “2 star” borrower may indicate that the interest rate for loan to that borrower must be in the range of 17% to 20%, for example. Lenders 106 can send communications 140 to borrowers 104 to request additional information, to communicate interest in lending capital to the borrower 104, or to send other communications 140. In a configuration, the lending service 101 provides a secure private email system that requires the lenders 106 and borrowers 104 to first log into the lending service 101 to be able to access the communications 140. In a configuration, the identity of the lender 106 is hidden from the borrower 104, although this disclosure is not so limited. In a configuration, the identity of the borrower 104 is hidden from the lender 104, although this disclosure is not so limited. In a configuration, the communications 140 are forwarded to other email services. In a configuration, the communications 140 can be proxied by the lending service 101, for example by providing a borrower 104 or lender 106 an email address on an email server of the lending service 101 that is forwarded or relayed to another email service. The communications 140 can be sent over the Internet 102.

Lenders 106 can present offers 142 to borrowers 104. In a configuration, an offer 142 is a loan of a portion, or all, of the money requested by a borrower 104. In a configuration, multiple lenders 106 can present offers 142 to borrowers 104 for the same loan. In a configuration, the lending service 101 can qualify the borrower 104 for an amount of money that is less than the borrower 104 requests. In a configuration, the lending service 101 sets the interest rate for the borrower 104 based on, for example, the ranking of the borrower 104 as described above. In a configuration, the lending service 101 can set a range of allowable interest rates and the lender 106 can present an offer 142 to the borrower 104 for an interest rate within the range set by the lending service 101. For example, if the borrower 104 is ranked by the lending service 101 as a “3 star” borrower, interest rates in the range of 12%-15% may be presented to the lender 106. When preparing an offer, the lender 106 can pick an interest rate within that range. Other loan parameters may also be determined based on the ranking of the borrower 104, such as maximum loan amount and length of the loan, for example. In a configuration, the lending service 101, borrower 104, or lenders 106 can set conditions for the offer 142, for example the offer 142 can be contingent upon the borrower 104 obtaining the full amount of the money requested by the borrower 104. In a configuration, the offer 142 can be contingent upon the borrower 104 receiving a portion, such as one-third, of the money requested. In a configuration, the offer 142 can be contingent upon additional information or loan guarantees (e.g., a personal loan guarantee) requested by the lender 106. In a configuration, a borrower 104 can present an offer to a lender 106.

Borrowers 104 can present counteroffers 144 to lenders 106. Conversely, lenders 106 can present counteroffers 144 to borrowers 104. For example, a borrower 104 can present a counteroffer 144 for a greater amount of capital from a lender 106 at a higher interest rate. Borrowers 104 can send an acceptance 146 of an offer 142 or counteroffer 144 from a lender 106. Conversely, a lender 106 can send an acceptance 146 of an offer 142 or counteroffer 144 to a borrower 104.

In a configuration, the lending service 101 can utilize a title company 108 to create a formal loan agreement 148, for example by providing paperwork for the parties 104, 106 to sign, whether physically or electronically. The title company 150 can hold funds 152 in escrow 150 until the formal loan agreement 148 is agreed to by both parties 104, 106. For example, the lender 106 can instruct a bank 110 to transfer funds 152 from the lender's 106 account to an escrow 150 account utilized by the title company 108. The title company 108 can hold the funds 152 in escrow 150 until the parties 104, 106 sign the formal loan agreement 148. In a configuration, the title company 108 can further hold all or a portion of the funds 152 in escrow 150 based on instructions from the lending service 101. For example, the lending service 101 may instruct the title company 108 or bank 110 to release or transfer funds 152 to the borrower 104 in set amounts at fixed periods or when threshold events have been met. For example, the lending service 101 may transfer funds 152 to the borrower 104 based on the subscription level of lenders 106 to the borrower's 104 listing 136. For example, when the borrower 104 receives offers 142 and sends acceptances 146 for more than one-third the total amount requested in the listing 136, the lending service 101 can instruct the title company 108 or bank 110 to transfer one-third of the total amount requested to the borrower's 104 account. When the subscription level exceeds two-thirds, the lending service 101 can release another one-third, and another one-third when the full amount of the listing 136 has been reached with lenders 104. In another example, the funds 152 can be released based upon the borrower 104 reaching certain threshold milestones, such as a product release or a store opening. In another example, the funds 152 can be released as soon as the borrower 104 and lender 106 sign the formal loan agreement 148.

In a configuration, the lending service 101 can generate a promissory note with fields of the promissory note automatically populated with the information received from the borrower 104 and the lender 106. Instead of using a title company 150, as described above, the bank 110 can transfer the funds from the lender's account (using an Automatic Clearing House (ACH) transfer request, for example) to an escrow account utilized by the lending service 101, as indicated by escrow account 151 in FIG. 1. Upon acceptance of the loan by the borrower 104, the lender funds can be transferred to an account of the borrower 104. Prior to transferring the funds to the account of the borrower 104, a lending service fee (or any other transactional charge) may be withdrawn from the lender funds and deposited in an accounts receivable associated with the lending service 101.

The borrower 104 can make payments 154 to the bank 110 that are credited back to the lender 106. The bank 110 and title company 108 can provide information to the lending service 101 regarding the status of the formal loan agreement 148, the funding 152, and the repayment 154 of the formal loan agreement 148. The lending service 101 can use this information to update and provide badges 126, 134 for the borrower 104 or lender 106. The borrower 104 or lender 106 can create posts 112, 118 relating to the badges 126, 134 that are posted to their pages of their social network 114, 116. In a configuration, the lending service 101 creates the post 112, 118 and the borrower 104 or lender 106 can add comments to the post 112, 118 before uploading the post 112, 118 to the borrower's 104 or lender's 106 social network 114, 116. The post 112, 118 can include a link or QR code 128 or a badge 126, 134. In a configuration, the lending service 101 can include a social network 114, 116 or page on a social network 114, 116. In a configuration, a borrower's activity in the social networking environment can affect the borrower's ranking, as determined by the lending service 101. For example, if a borrower 104 is able to generate a positive social network reputation, the reputation can be used as an input factor in determining the ranking of the borrower 104. A social reputation may be quantified using any suitable metric, such as a number of “likes” on a social networking page or the number of “connections”, the number of “followers”, for example. Moreover, a social media presence or reputation may also be determined, at least in part, by the borrower's social media reputation as established by other entities. For example, a borrower's “positive feedback” percentage in EBAY®, or other e-commerce websites, can be used by the lending service 101 as a factor in determining a borrower's ranking. As is to be appreciated, information gathered by third parties may be accessed by the lending service 101 by any suitable technique, such as application programming interfaces (APIs), for example.

In one configuration, the borrower 104 can make payments 154 to the lending service 101 instead of the bank 110. The payments 154 may be transferred from an account associated with the borrower 104 to an account associated with the lending service 101 via ACH transfer. A subsequent ACH transfer can be used to transfer the payment funds from the account associated with the lending service 101 to the account associated with the lender 106. Depending on a monetization structure, various fees associated with the lending service 101 may be transferred to an accounts receivable associated with the lending service 101 prior to, or concurrently with, the transfer of the payment funds to the lender 106. It is noted that fees may be based on a percentage of the transfer, a percentage of the loan, a flat-rate transaction fee, or any other suitable fee structure.

Although the system 100 and method presented describe posts to borrower's 104 or lender's 106 social networks 114, 116, other means of sending information to third parties and other forms of social media are also considered, such as email messages, a short message service or SMS message, a message from a web log, and even phone, voicemail, or other audible messages. Web logs are commonly referred to as blogs and can include microblogs and blog messages.

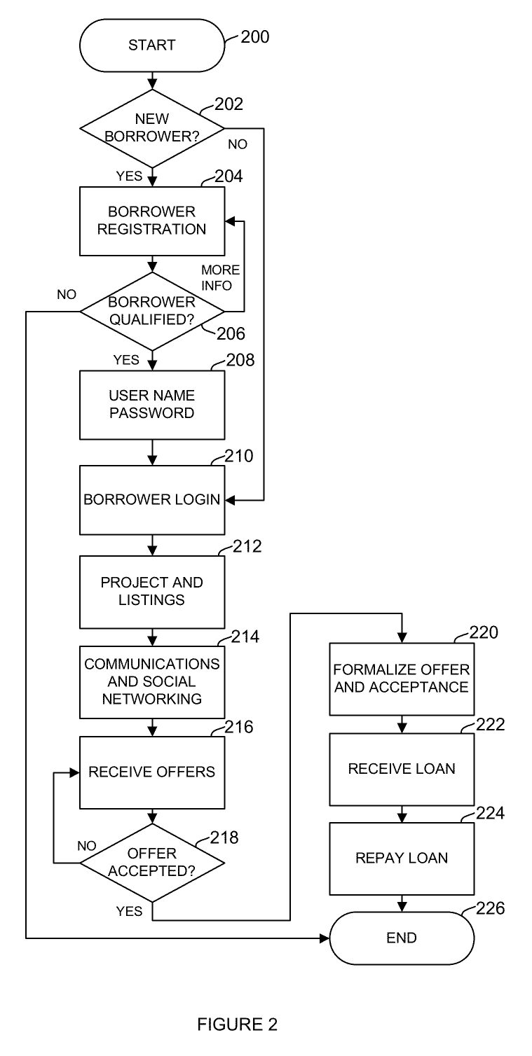

FIG. 2 is an exemplary flow diagram of an example operation of the system 100 for a borrower 104. Operation starts with start block 200 labeled START. Processing continues to decision block 202. In decision block 202, if the borrower 104 is a new borrower, then processing continues to process block 204, otherwise processing continues to process block 210. In process block 204, the borrower 104 registers with the lending service 101. Registration can include providing bank account information, for example bank routing numbers, and signing or accepting a site license agreement, an end-user licensing agreement (EULA), a terms of use agreement, or other kind of license or agreement. Registration can also include a loan term agreement that contains the standard terms for loans between borrowers 104 and lenders 106 unless specifically changed by the parties 104, 106. Registration can include a check of the credentials of the user's business, for example by requiring an upload or a download of state filings 124 such as business filings with a secretary of state, credit information 122 such as credit scores from credit agencies, tax payment history, a Dun & Bradstreet® Report, information regarding the number of years the business has been in business and any previous names the business may have had, and other financial information such as current outstanding loans, previous loans, and letters of recommendation from lenders 106. Various information gathering techniques can be used to gather relevant information regarding the borrower 104. In one configuration, for example, one or more APIs are used to retrieve information from third-party databases, such as databases maintained by a governmental body, credit agencies, and so forth.

Registration can also include requiring private information about the user, such as the identification of the actual user, a verification of the user credentials, such as a check of the user's driver's license, bankruptcy and lawsuit history, credit scores such as FICO® scores from accredited credit agencies, or other information relevant for determining credit worthiness. Registration can also include the social security number of the user. However, in a configuration the social security number of the user is not stored by the lending service 101, but rather is passed through to a credit rating agency. Processing continues to decision block 206.

In decision block 206, the lending service 101 uses the information provided by the borrower 104 in process block 204 to qualify the borrower 104. If the borrower 104 has not provided sufficient information to the lending service 101, then processing continues back to process block 204 where the borrower 104 can be prompted to add additional information. If the lending service 101 determines that the borrower 104 is not qualified then processing terminates at end block 226. In configurations, the borrower 104 can be invited to reapply. If the lending service 101 determines that the borrower 104 is qualified, then processing continues to process block 208. In process block 208, the borrower 104 creates a user name and password combination to log into the lending service 101. The lending service 101 can also include additional safeguards such as authentication procedures and include authentication devices. In a configuration these operations can be performed before the applicant has been qualified as a borrower 104. Processing continues to process block 210.

In process block 210, the borrower 104 logs into the system 100 using the user name and password. When the borrower 104 logs into the system 100, the borrower 104 is presented a welcome screen. The welcome screen can include information about the borrower's 104 listing 136, such as the current amount of funding by lenders 106. For example, the welcome screen can include a dashboard that shows the borrower's 104 listing 136, or other borrowers' 104 listings 136, for example other local borrowers 104 in the same or similar geographic area or the same or similar business or industry. The dashboard can include information or a graphic map of active lenders 106 in the borrower's 104 nearby geographic area, for example by showing a map of lenders 106 within a short radius of the borrower 104. The map can include an identifier, such as a flag, that indicates the presence of, or active lending by, a lender 106 in that geographic area shown on the map.

The identity of the lender 106 can be hidden from the borrower 104, while still providing the general geographic area of the lender 106. For example, the geographic area of the lender 106 can be shown as associated with a particular neighborhood, a street, a town, a county, or a different level of granularity as selected by the lender 106 or the lending service 101. This enables lenders 106 to draw the attention of borrowers 104 to the fact that a lender 106 is investing in a particular geographic area, or is located in a particular geographic area, without necessarily disclosing the lender's 106 identity. The dashboard can also include information about the borrower's 104 investments (e.g. if the borrower 104 is also a lender 106), neighborhood information and lender 106 investments in those neighborhoods, and business type or industry type performance evaluations, such as repayment rates. Processing continues to process block 212.

In process block 212, the user can create a project that becomes a searchable listing 136 for lenders 106. The project can contain information including the name of the business, the address of the business, the management team or owner of the business, a geographic location associated with the business, for example a common name of an area used by people familiar to the area, the amount of capital being requested, the interest rate and loan terms, and any other information the borrower 104 provides to the lending service 101 uses the information in the project to create the listing 136 that is searchable by the lenders 106. In a configuration, the listing 136 is identical to the project. In a configuration, the project can have more or less information than the listing 136. For example, the listing 136 can be a standardized set of fields for searching, while the project can include additional information about the borrower, for example history of the business, pictures of the business, customer feedback, recent important projects and successes, hyperlinks or other links to additional information about the borrower or business, for example newspapers reviews or articles, or any other pertinent information provided by the borrower. Processing continues to process block 214.

In process block 214, the borrower 104 or lending service 101 use communications 140 and social networking to communicate information about the borrower 104 to potential lenders 106. For example, when the borrower 104 creates a listing 136 or project, a copy of, or link to, the listing 136 or project can be sent to lenders 106. For example, the listing 136 can be sent to a pool of lenders 106 who have preferences, or have used search terms, that most closely match aspects of the borrower's 104 listing 136 or projects. In another example, a new listing 136 can be displayed on a lender's 106 welcome screens or dashboards after they log in to the system 100. Communications 140 can also include posts 112, 118 on social networks 114, 116. Communications 140 can also be email or other messages sent to potential lenders 106. Communications 140 can also include providing searchable listings 136 to lenders 106. Lenders 106 can send communications 140 to borrowers 104 to express interest in lending capital to the borrower 104 or to obtain additional information from the borrower 104. Processing continues to process block 216.

In process block 216, the borrowers 104 receive offers from lenders 106. For example, a lender 106 can use the lending service 101 to send an offer 142 to the borrower 104 with terms including the amount being offered, the interest rate, and the term. Processing continues to decision block 218. In decision block 218, the borrower 104 can accept the offer 142 and processing continues to process block 220. The borrower 106 can also reject the offer or present a counteroffer 142 and processing continues back to process block 216.

In process block 220, the offer 142 and acceptance 146 is formalized, for example by the parties 104, 106 signing loan papers, for example with a title company 108 as described previously. Processing continues to process block 222. In process block 222, the borrower receives the loan, for example from a bank 110 or escrow account controlled by the title company 108. Processing continues to process block 224. In process block 224, the borrower 104 repays the loan to the lender 106. In a configuration, the borrower 104 repays the principal and interest directly to the lenders 106, for example through monthly automated funds transfers using one or more banks 110. Processing continues to end block 226 where processing terminates.

The borrower 104 can be a business borrower, with the ownership structure of the business being a single individual, a group of individuals, an entity, a group of entities, or any other suitable grouping of individuals and entities. By way of example, borrower 104 may be a composite of multiple owners of a particular business or endeavor that is seeking a capital. If the borrower 104 is two co-owners of a business, for example, the ranking of the borrower 104 utilized by the lending service 101 can be an average or other weighting of the individual co-owner's rankings. Similarly, credit scores and other various qualifications or factors related to the individual co-owners can be combined by the system lending service 101 using any suitable technique, such as an averaging or weighted averaging technique, for example.

It is also to be appreciated that a borrower 104 can own, or otherwise be affiliated, with a plurality of companies or other entities that are each seeking to borrow funds through the system 100. In such configurations, activities of a borrower relative to one of its companies can affect or influence lending activity that is related to the borrower's other companies. By way of example, a borrower 104 may be seeking funding for both a first endeavor and a second endeavor, which are unrelated endeavors. If that borrower successfully pays off a loan that was directed to the first endeavor, that successful loan payoff can raise the borrower's ranking or score with respect to both the first endeavor and the second endeavor. In other words, positive or negative interactions relative to one of the borrower's entities that are accessing capital through the system 100 can carry over and impact interactions with the borrower's other entities.

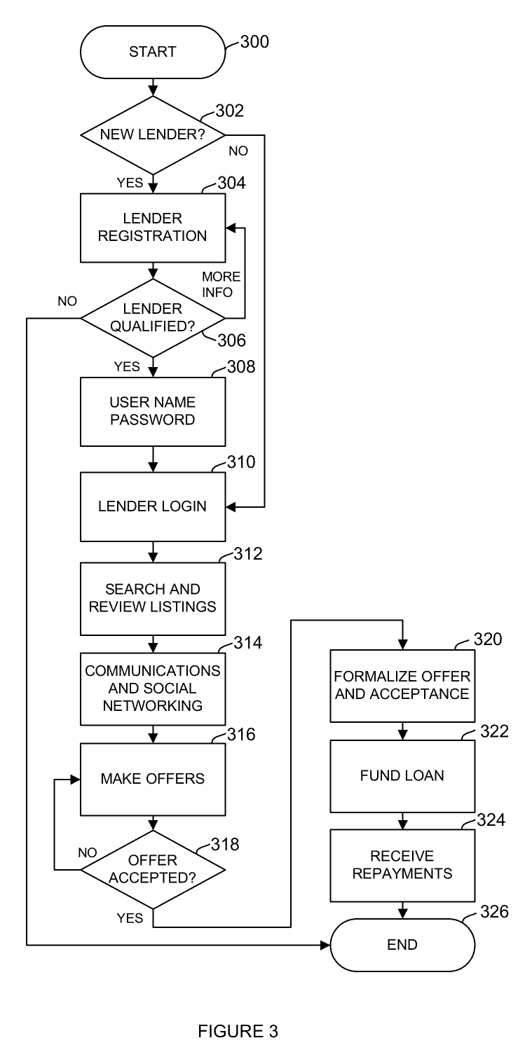

FIG. 3 is an exemplary flow diagram of an example operation of the system 100 for a lender 106. Operation starts with start block 300 labeled START. Processing continues to decision block 302. In decision block 302, if the lender 106 is a new lender, then processing continues to process block 304, otherwise processing continues to process block 310. In process block 304, the lender 106 registers with the lending service 101. Registration can include providing bank account information, for example bank routing numbers, and signing or accepting a site license agreement, an end-user licensing agreements (EULA), a terms of use agreement, or other kind of license or agreement. Registration can also include a loan term agreement that contains the standard terms for loans between borrowers 104 and lenders 106 unless specifically changed by the parties 104, 106. Registration can include setting preferences, such as what information about the lender is revealed to borrowers 104, the maximum amount of money available to lend, a typical range of money to be lent in a typical loan, default search terms for displaying potential borrowers 104, geographic area and industry preferences, and other preferences. Registration can include a check of the credentials of the lender 106, for example by requiring an upload or a download of state filings 124 such as business filings with a secretary of state, credit information 122 such as credit scores from credit agencies, tax payment history, a Dun & Bradstreet® Report, information regarding the number of years the lender 106 has been in business and any previous names the lender 106 may have had, and other financial information such as bank account information, current outstanding loans, previous loans, and other lender 106 qualification information. Processing continues to decision block 306.

In decision block 306, the lending service 101 uses the information provided by the lender 106 in process block 204 to qualify the lender 106. If the lender 106 has not provided sufficient information to the lending service 101, then processing continues back to process block 304 where the lender 106 can be prompted to add additional information. If the lending service 101 determines that the lender 106 is not qualified then processing terminates at end block 326. In configurations, the lender 106 can be invited to reapply. If the lending service 101 determines that the lender 106 is qualified, then processing continues to process block 308. In process block 308, the borrower 104 creates a user name and password combination to log into the lending service 101. The lending service 101 can also include additional safeguards such as authentication procedures and include authentication devices. Processing continues to process block 310.

In process block 310, the lender 106 logs into the system 100 using the user name and password. In some configurations, a lender 106 may have multiple accounts, which can each have different administrative and access rights. For example, if lender 106 is a lending institution, various employees of the lender 106 can each log into the system 100 with a user-specified user name and password. Users with different roles or different titles within the lending institution can have access to varying levels of information, be granted permission to perform different types of functions, and run different types of reports, for example. Thus, a vice president of the lender 106 logging into the system 100 can have more rights and permissions than a loan officer of the lender 106.

In any event, when the lender 106 logs into the system 100, the lender 106 can be presented a welcome screen. The welcome screen can include information about new or popular lending opportunities. For example, the welcome screen can include a dashboard that shows borrowers' 104 listings 136. Listings 136 can be displayed based on a number of criteria. For example listings 136 that are close to receiving all of the requested capital can be prioritized so that the lender 106 does not miss the lending opportunity. In another example, popular new listings 136 that are receiving funding quickly can similarly be prioritized. In another example, new borrowers 104 and listings 136 that meet one or more preferences configured by the lender 106 can be displayed, for example listings 136 for borrowers 104 in particular geographic areas or in particular businesses or industries. The dashboard can include information or a graphic map of borrowers 104 in nearby geographic area, for example by showing a map of borrowers 104 within a short radius of the lender 106, for example 10 miles. The map can include an identifier, such as a flag, that indicates a borrower 104 in that geographic area shown on the map. The welcome screen or dashboard can include information about the lender's 106 investments with borrowers 104, for example loan acceptances 146 from borrowers 104, repayment amounts by borrowers 104 including recent repayments 154, and the lender's 106 account balances and capital available for additional investment. The dashboard can also include information neighborhoods receiving investments and the kinds of investments in those neighborhoods, and business type or industry type performance evaluations, such as repayment rates. Processing continues to process block 312. The particular information displayed on the user's dashboard can be determined by the particular user's access rights or other status indicators, for example.

The lender 106 can click on any of the listings 136 to obtain additional information about the listing 136 and borrower 104. As the lender 106 clicks on potential borrowers 104, the lending service 101 can develop a profile of likely borrowers 104 for the lender 106 and customize or prioritize listings based on the lender's 106 actions. In addition, a dynamic or heuristic preference can be using in addition to, or instead of, the lender's 106 preferences set in process block 304, searches in process bock 312, loan offers in process block 316, loan funding in process block 322, and repayments in process block 324. Processing continues to process block 312.

In process block 312, the lender 106 can create searches 138 for listings 138 or borrower 104 projects. The lending service 101 can provide a suitable search mechanism or integrate that function with a service provided by a search provider. The lender 106 can search through the listings 136 for acceptable projects using fields such as the name of the borrower 104, the borrower's company's name, a geographic identifier, a street address, a city, a state, or other searchable indicia. For example, the lending service 101 can provide a picture of a geographic area, for example using a map from a map provider, with information from the lending service's 101 databases about potential borrowers 104, to provide a map of borrowers 104 who meet the search criteria of the lender 106.

In addition to receiving geographic information entered by the lender 106 in a search 138, the lending service 101 can receive location information from computing equipment used by lenders 106. The lending service 101 can dynamically update the listings 136 presented to the lenders 106 using that location information. For example, if the lender 106 is using a mobile computing device to access the system 100, the geographic position of the lender 106 can be provided to the system 100. In a configuration, the mobile computing device can provide location data to the lending service 101, for example Global Position System (GPS) data or position data provided by the mobile telephone network.

In another configuration, a lender 106 can scan a QR code 128 at a borrower's 104 business premises or can scan a QR code 128 in marketing materials about the borrower 104. This advantageously permits a potential lender 106 to find and develop lending opportunities while visiting brick-and-mortar establishments, while traveling, or at trade related events such as conferences, conventions, trade shows, and other events. Because lenders 106 can provide the lending service 101 with bank routing numbers, and because the loan terms can be pre-approved or previously negotiated, lenders 106 can lend capital in real time, at the moment of impact with the borrower 104. In a configuration, the lending service 101 can list other borrowers 104 in the same general geographic area or business. The lending service 101 can update the welcome screen, dashboard, or search results with listings 136 based at least in part on the current position of the mobile computing device or the geographic area associated with the borrower 104 displaying the QR code 128. Processing continues to process block 314.

In process block 314, the lender 106 or lending service 101 use communications 140 and social networking to communicate information about the lender 106, the borrower 104, and the listing 136 to other potential lenders 106 or borrowers 104. It can be advantageous for a lender 106 to find other lenders 106 for a borrower 104 so that the borrower 104 can quickly receive the entire loan amount they desire. Communications 140 can include posts 112, 118 on social networks 114, 116. Communications 140 can also be email or other messages sent to other potential lenders 106 and potential borrowers 104. Communications 140 can also include providing searchable listings 136 to other potential lenders 106. Lenders 106 can send communications 140 to borrowers 104 to express interest in lending capital to the borrower 104 or to obtain additional information from the borrower 104. Processing continues to process block 316.

In process block 316, the lender 106 make offers 142 to borrowers 104. For example, a lender 106 can use the lending service 101 to send an offer 142 to the borrower 104 with terms including the amount being offered, the interest rate, and the term. Processing continues to decision block 318. In decision block 218, the borrower 104 can accept the offer 142 and processing continues to process block 320. The borrower 106 can also reject the offer or present a counteroffer 142 and processing continues back to process block 316. In a configuration, the lending service 101 can provide an option to the borrower 104 that allows the borrower 104 to accept offers that meet certain criteria without further confirmation from the borrower 104. This configuration can facilitate the borrowing process in instances where multiple lenders 106 are expected to subscribe to loaning fractional amounts of the capital requested by the borrower 104 and where the interest rate for the loan is likely to be set at a fixed rate.

In process block 320, the offer 142 and acceptance 146 is formalized, for example by the parties 104, 106 signing loan papers. For example, the parties can sign loan papers with a title company 108 as described previously. In a configuration, the loan formalizing process is performed electronically, for example by the borrower electronically signing or e-signing documents provided by the lender 106 or lending service 101. As is to be appreciated, the particular documents provided by the lender 106 or lending service 101 can be specific to the type of loan product involved in the transaction, such as an installment loan, a line of credit, an interest-only loan, a balloon loan, an amortized loan, a partially amortized loan, a secured loan, an unsecured loan, and so forth. Processing continues to process block 322. In process block 322, the lender 106 funds the loan, for example by requesting a bank 110 to deposit money in a borrower's 104 account, or into an escrow 150 account controlled by the title company 108. Processing continues to process block 324. In process block 324, the lender 106 receives repayment of the loan from the borrower 104. In configurations, the lender receives principal and interest repayments 154 from the borrower 104, for example through monthly automated funds transfers using one or more banks 110. Processing continues to end block 326 where processing terminates.

In a configuration, the lender 106 can create a closed group, such as a collection of specified lenders and borrowers. Closed groups may be populated with members using a variety of techniques. For example, members of the closed group (such as a plurality of borrower and a plurality of lenders) may each elect into the closed group. In one configuration, a managing entity of the closed group can extend invitations to join a closed group. Upon receiving the invitation, the receiving party can decide to join the closed group.

The closed group may be, for example, a group of lenders and borrowers in a specific geographic region, or related through a civic, educational, or other type of connection or objective. For example, a chamber of commerce can facilitate a closed group that includes lenders in a particular city and borrowers in that city seeking funding. Thus, the lending service 101 can serve as a platform for local lenders to interact with local borrowers. In another embodiment, a closed group can include borrowers and lenders that are part of an academic institution's alumni network. In other embodiment, the closed group can include lenders interested in investing in arts and entertainment. Borrowers in the group can include, for example, artists and writers, such as playwrights, sculptures, screenwriters, and so forth.

As is to be appreciated a lender 106 may be a member of zero closed groups, one closed group, or more than one closed group. Similarly, a borrower 104 may be a member of zero closed groups, one closed group, or more than one closed group. The lending service 101 can facilitate searching functionality to allow a lender 106 or borrower 104 to search for closed groups that may be of interest. In one configuration, the lending service 101 can recommend closed groups to a lender 106 or borrower 104 based on various characteristics of the lender 106 or borrower 104, such as a geographical location, an associated industry, and so forth.

The lender 106 can be any of a variety of lender types, such as, for example, a banking institution or other financial services entity, a non-financial services entity, or an individual. The information provided to the lender 106 by the lending service 101 or requested from the lender 106 can vary based on lender type. Lenders 106 that are accustomed to navigating the lending process and the accompanying securities and banking regulations can be provided with different information than less sophisticated individual lenders who may or may not be as familiar with the process. The lender type can be obtained or otherwise determined by the lending service 101 during the lender registration process 304, for example.

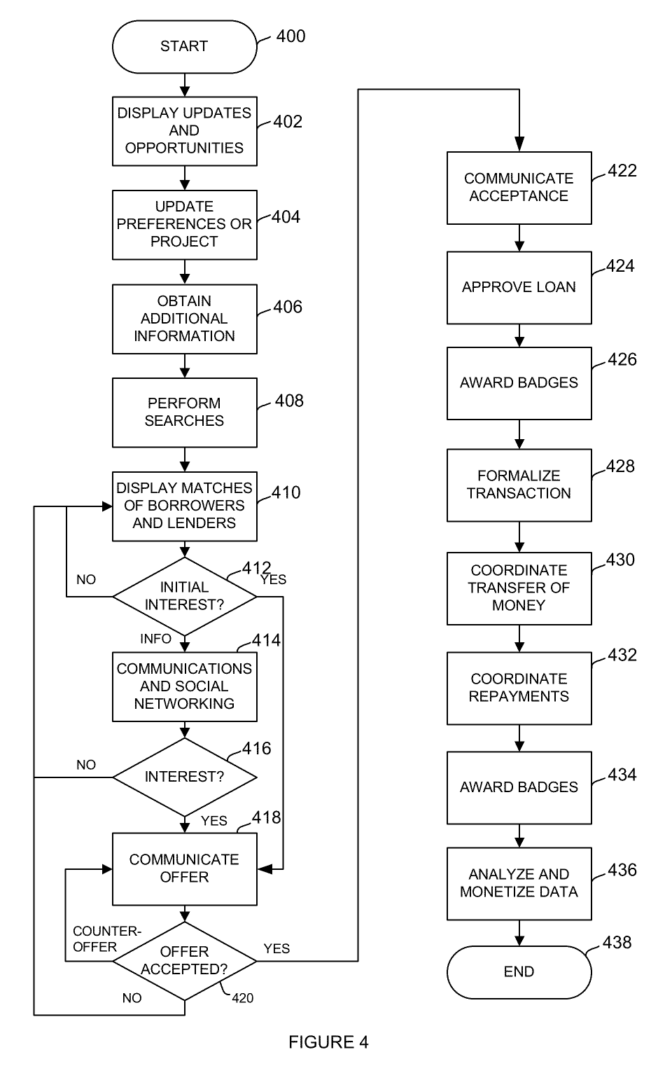

FIG. 4 is an exemplary flow diagram of an example operation of a system 100 for facilitating loan transactions between the borrowers 104 and lenders 106. Operation starts with start block 400 labeled START. Processing continues to process block 402. In process block 402, the system 100 displays updates and opportunities to the user of the system 100, for example a borrower 104, a seller 106, or an administrator of the system 100. The updates and opportunities can be new listings of borrower 104, offers from lenders 106, information regarding funding of 152 of loans, information regarding repayments 154 of loans. The updates and opportunities can be displayed in a customizable dashboard. Processing continues to process bock 404. In process block 404, the user can update user preferences and projects in the system 100. For example, if the user is a lender 106, updating the preferences can include updating the geographic area of interest for the lender 106, or updating the kinds of borrowers 104 that the lender 106 is interested in loaning capital to. In another example, if the user is a borrower 104, the borrower 104 can update the project or listing, for example by adding additional information to the listing, or make other changes to improve the listing 138 and make the project more attractive to potential lenders 106 Processing continues to process block 406.

In process block 406, the system 100 obtains additional information. If the user is a lender 106, the system 100 can obtain information such as the current geographic position of the lender 106, for example using GPS data from a mobile computing device carried by the lender 106. In another example, if the user is a borrower 104, the borrower 104 can associate a QR code 128 with a listing 136 in the system 100 so that the lending service can use the QR code 128 to direct potential lenders 106 to the listing 136 of the borrower 104. Processing continues to process block 408.

In process block 408, searches can be performed to match potential borrowers 104 and lenders 106. The searches can match borrowers 104 with lenders 106 based on criteria such as the lender's 106 preferences, the lender's 106 current geographic position, the borrower's 104 capital requirements, and the borrower's 104 and lender's 106 badges 126, 134. Processing continues to process block 410.

In process block 410, the system 100 displays matches of borrowers 104 and lenders 106. For example, a borrower 104 may see a list of potential lenders 106 that might be interested in loaning capital to the borrower 104, and a lender 106 may see a list of listings 136 of borrowers 104 that match the lender's preferences. The matches can be searchable, for example by keyword. In a configuration the matches that are displayed can be organized in a list, for example by listing the other parties 104, 106 or listings 136 by name, business name, geographic area, loan amount, interest rate, types of badges, industry or business type, typical amount loaned, lender preferences, or information in the listing. In a configuration, the list of matches can be sorted by fields such as by owner name, business name, geographic area, loan amount, interest rate, by badge type, by industry or business type, by typical amount loaned, by lender preference, or by other information from the listing. Processing continues to decision block 410.

In decision block 410, if the user of the system 100 has initial interest in one of the potential matches displayed by the system 100, then the user of the system 100 can take further action with the potential match. For example, if the user of the system 100 is interested in making an offer to another party 104, 106 listed in the potential matches, then the user of the system 100 can click on an offer button associated with the listing 136 or party 104, 106 in the displayed matches and processing continues to process block 418. If the user of the system 100 is interested in obtaining additional information from a party 104, 106, then the user of the system 100 can click on a request for additional information button associated with the listing 136 or party 104, 106 and processing continues to process block 414. If the user of the system 100 is not interested in any of the potential matches displayed by the system 100, then processing continues back to process block 410 where additional matches can be displayed by the system 100.

In process block 414, the user of the system 100 can communicate with the other party 104, 106, for example by requesting additional information. For example, a borrower 104 can provide an indication of an acceptable interest rate that the borrower 104 would accept from the lender 106, or a lender 106 could request information about the business, such as a business plan. The communications can take place using an email service provided by the lending service 101. The communications can include posts to social network pages 114, 116. For example, the lender 106 may know a member of the lender's social network 116 who would be interested in loaning capital to the borrower 104. The lender 104 could place a post 118 on the lender's social network 116 with information about the borrower 104 or borrower's 104 listing 136. Similarly, the borrower 104 can place a post 112 on the borrower's social network 114 about the lender 106, for example if borrower 104 becomes aware that the lender 106 is interested in funding similar businesses to the borrower 104 or businesses in the borrower's 104 geographic area. Social networking can assist both borrowers 104 and lenders 106, as borrowers 104 are likely to know people and businesses in their same field of endeavor or geographic location that may not otherwise know that there is a lender 106 who could be interested in loaning capital to their businesses. Similarly, lenders 106 often know other lenders 106 who could be interested in lending opportunities recommended by colleagues, even if those lending opportunities fall outside of the normal preferences of a particular lender 106. Because social networks allow posts 112, 118 to be quickly disseminated to other members of the social networks 114, 116, opportunities for borrowing capital and lending capital can go viral and provide additional matches between borrowers 104 and lenders 106, thereby potentially speeding up the subscription of borrower 104 requests for capital by lenders 106. Processing continues to decision block 416.

In decision block 416, if after communicating with the other party 104, 106 the user of the system 100 is interested in making an offer to the party 104, 106, then the user of the system 100 can click on an offer button associated with the listing 136 or party 104, 106 in the displayed matches and processing continues to process block 418. Otherwise, processing returns to process block 410 where additional matches can be displayed by the system 100.

In process block 418, the user of the system 100 communicates an offer 142 to the other party 104, 106. Processing continues to decision block 418. In decision block 418, the other party 104, 106 can accept the offer 142 and processing continues to process block 422. The other party 104, 106 can communicate a counteroffer to the user of the system 100 and processing continues back to process block 418 and the party 104, 106 communicates the counteroffer to the user of the system 100. For example, a lender 106 can communicate an offer of a loan to the borrower at a first interest rate, and the borrower can communicate a counteroffer at a second interest rate. The other party 104, 106 can reject the offer and processing continues back to process block 410.

In process block 420, the system 100 communicates the acceptance of the terms of the loan from one party 104, 106 to the other party 104, 106 indicating that the loan has been agreed upon by both parties 104, 106. Processing continues to process block 424. In process block 424, the lending service 101 can optionally perform the operation of approving the loan. In a configuration, the operation of approving the loan can be performed manually by an administrator of the lending service 101. In a configuration, the operation of approving the loan can be performed by an algorithm running on a computing device operated by the lending service 101. For example, for smaller or fractional loan amounts an algorithm can approve the loan without requiring an administrator of the lending service 101 to review the loan. For larger loan amounts, an administrator of the lending service 101 can review the loan, and if necessary make any necessary changes to the loan by contacting the parties 104, 106. Processing continues to process block 426.

In process block 426 the lending service 101 can award badges 126, 134 to the parties 104, 106. For example, badges 126, 134 can be awarded for certain threshold events. For a borrower 104, one kind of badge can be awarded upon the first lenders 106 providing funding for the project. When searching, lenders 106 can search by badges 126, for example to look for borrower 104 listings 136 that other lenders 106 are also interested in. Other badges 126 can be awarded for other thresholds, for example having various levels of subscription to the borrower's 104 project or listing 136, such as one-third, one-half, two-thirds of the loan subscribed to by other lenders 106, again to indicate levels of interest of other lenders 106. In another example, the borrower 104 can receive a badge 126 for a successful subscription of the total amount requested in the listing 136. If the borrower 104 creates a new listing 136, a badge 126 indicating a past successful subscription can provide a measure of the anticipated level of interest in the borrower's 104 new listings 136.

For the lender 106, badges 134 can be awarded for the number of listings 126 they have subscribed to. Badges 134 can also be awarded for reaching threshold dollar amounts of loans they have subscribed to. These badges 134 can be indications to borrowers 104 and other lenders 106 about the quality and type of lenders 106 that are subscribing to their listings 136. For example, because lender 106 identities can be hidden, badges 134 can be important indicators of whether the borrower 104 is receiving funding from friends and family or more professional lenders 106. For example, a borrower 104 who is receiving loan subscriptions from lenders 106 who have few badges 134, or have badges 134 indicating minimal amounts of money previously lent to borrowers 104, may be receiving money primarily from friends and family, rather than from experience lenders 106. By comparison, a borrower 104 who has a listing 136 that is subscribed to by lenders 106 having multiple badges 134, and particularly badges 134 indicating large amounts of loans to other borrowers 106, may be attracting the interest of serious investors. Therefore, badges 134 can provide additional information to lenders 106 about the risks involved with lending to a particular borrower 104. Processing continues to process block 428.

In process block 428, the offer 142 and acceptance 146 is formalized, for example by the parties 104, 106 signing loan papers. For example, the parties can sign loan papers with a title company 108 as described previously. In a configuration, the loan formalizing process is performed electronically, for example by the borrower electronically signing or e-signing documents provided by the lender 106 or lending service 101. Processing continues to process block 430.

In process block 430, the lending service 101 coordinates the transfer of capital from the lender 106 to the borrower 104. For example, lending service 101 coordinates with a third party bank 110 to have the lender 106 deposit money in a borrower's 104 account, or into an escrow 150 account controlled by the title company 108 and have the title company 108 release funds into the borrower's 104 account. Processing continues to process block 432.

In process block 432, the lending service 101 coordinates and sets up the transfer of repayments 154 from the borrower 104 to the lender 106. In configurations, the lender receives principal and interest repayments 154 from the borrower 104, for example through monthly automated funds transfers using one or more banks 110. In a configuration, the lending service 101 receives information from the banks 110, the borrower 104, or the lender 106 regarding the status of the repayments 154. The borrower 104 makes repayment 154 of the loan until the loan is paid in full. The borrower 104 can default on the loan by failing to make payments. The borrower 104 can be late on payments, and penalties can be applied to future repayments 154. Processing continues to process block 434.

In process block 434, the borrower 104 receives a badge 126 for repayment of the loan, or in the case of default a badge 126 indicating the default on the loan. A badge 126 for full repayment of a loan can help the borrower 104 to build a reputation among lenders 106 and improve the borrower's 104 ability to attract future loans. For example, the badge 126 may be used by the lending service 101 to favorably impact the ranking of the borrower 104. The badge 126 can be particularly advantageous for borrower's 104 who have bad credit, no credit, or have had a bankruptcy in their past. In one configuration, a particular badge type, or number of badges obtained by a borrower, may increase the borrower's ranking by a certain value. For example, subsequent to a “2 Star” borrower successfully repaying a loan, the lending service 101 may increase the borrower's ranking to a “3 Star” status for subsequent listings. Additionally, the badge 126 for completing repayment of the loan can be used as a factor by the lending service 101 and lenders 106 in determining the interest rates available to the borrower 104 for future loans. The lender 106 can also receive a badge 134 to indicate that the lender was repaid in full. For example, this badge 134 for the lender can be a good indication to other lenders 106 about whether the lender 106 is writing loans to high risk borrowers 104, or is providing loans to lower risk borrowers 104. Processing continues to process block 434.

In process block 434, the lending service 101 can analyze the listings 136, searches 138, offers 140, counteroffers 142, acceptances 146, repayments 154, badges 126, 134 and other information. The lending service 101 can develop algorithms to build borrower 104 and lender 106 profiles, to perform risk analysis and develop information useful to borrowers 104, lenders 106, banks 110 and other third parties. The lending service 101 can monetize the information, for example by selling the results of an analysis to third parties. The results can preserve the anonymity of borrowers 104 and lenders 106. Processing continues to end block 438 where processing terminates.

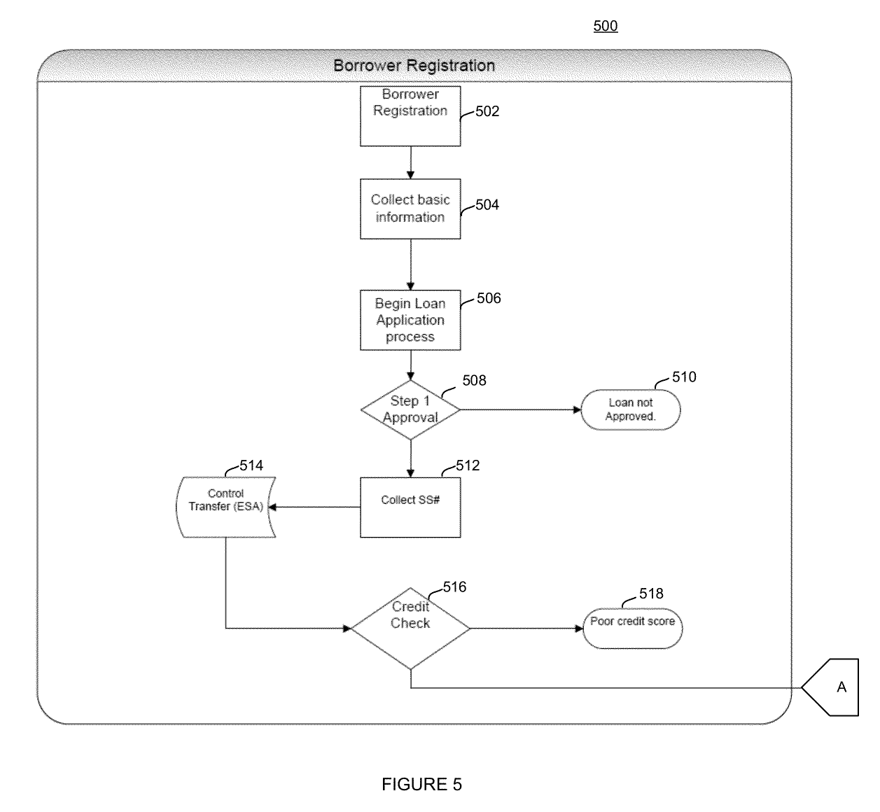

FIG. 5 presents an exemplary flow diagram for a borrower registration process 500 of the lending service 101 for creating lending opportunities between lenders 106 and borrowers 104. In process block 502 a borrower 104 begins borrower registration, for example by viewing a web page of a lending service 101. The registration process can include agreeing to a loan term agreement, site license agreement, an end-user licensing agreements (EULA), a terms of use agreement, loan term agreement that contains the standard terms for loans between borrowers 104 and lenders 106 unless specifically changed by the parties 104, 106, and other kind of license or agreements. Processing continues to process block 504 where basic information about the borrower is collected, for example the borrower's 104 name, address, business name, the number of years the business has been in business and any previous names the business may have had, the requested loan amount, the borrower's 104 financial information, business filings with a secretary of state, account information, for example a bank routing number, tax payment history, and other financial information such as current outstanding loans or previous loans. Processing continues to process block 506.

In process block 506, the loan application process begins. A fee may be collected by the lending service 101 for processing the application. As part of the loan application process, the lending service 101 can verify basic information provided by the borrower 104 and also obtain a Dun & Bradstreet® report about the borrower's 104 business or similar information. Processing then continues to decision block 508. In decision block 508, the lending service 101 analyzes the information about the borrower 104 and the capital request from the borrower 104. The lending service 101 can use an algorithm running on a computing device, for example a desktop, server or distributed server, laptop, mobile device, or other computing device having a processor, memory, and computer instructions running thereon. The algorithm can determine whether to reject the loan. If the loan is rejected, processing terminates at end block 510 and the borrower 104 is informed of the rejection of their loan application. Otherwise, processing can continue to process block 512.

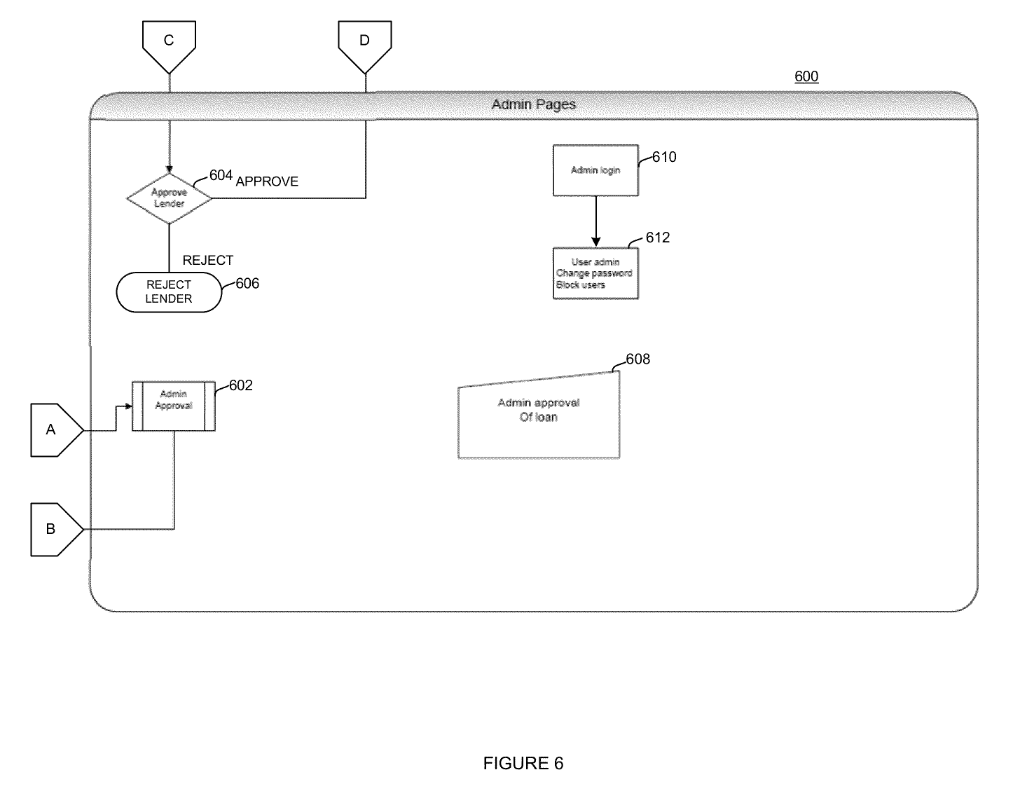

In process block 512, the lending service can request the social security number of the borrower 104. In a configuration the social security number of the borrower 104 is not stored by the lending service 101. Instead, the social security number is passed through to a credit rating agency as illustrated by stored data block 514, where the credit agency performs a credit check of the borrower 104 using at least the borrower's social security number, and returns at least one of a credit score and a credit report to the lending service 101. Processing continues to decision block 516 where the lending service 101 performs a credit check using at least one of the credit score and the credit report. If the borrower 104 has too low of a credit score for the requested amount of capital, or if there is adverse information in the credit report, or a lack of information indicative of credit worthiness, then processing terminates at end block 518 and the borrowers 104 is informed that their credit score is too low for the requested loan. Otherwise, processing continues to process block process block 602 of FIG. 6, as indicated by off-page reference A.

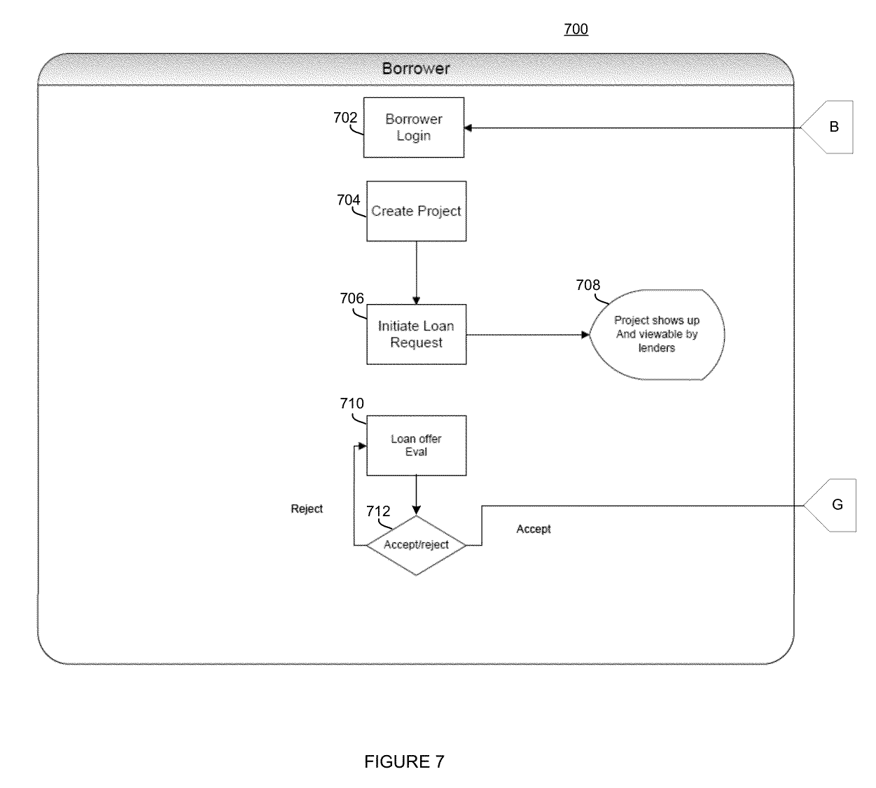

FIG. 6 presents an exemplary flow diagram for administrator processes 600 of the lending service 101 for creating lending opportunities between lenders 106 and borrowers 104. In process block 602, an administrator, or a process performing an administrator operation for the lending service 101, approves the loan for the borrower 104. In a configuration, the amount of the loan can be less than the amount requested by the borrower 104, and can be, for example, dependent upon the credit score or information provided by the borrower 104. The administrator can provide the borrower 104 with a username and password to access the lending service 101. Processing can continue to process block 702 of FIG. 7, as indicated by off-page reference B.

FIG. 7 presents an exemplary flow diagram for a borrower dashboard process 700 of the lending service 101 for creating lending opportunities between lenders 106 and borrowers 104. In process block 702 of FIG. 7, the borrower 104 logs into a home page of the lending service 101 using the username and password from process block 602 and views a borrower 104 dashboard. Once the borrower 104 has logged on to the lending service 101, processing can continue to process block 704 where the borrower 104 can create a project to request funding of a loan using a listing 136 associated with the project that is presented to lenders 106. Processing continues to process block 706 where the borrower 104 initiates the loan request, for example by publishing the listing 136 for the project. The listing 136 is published and viewable by lenders 106 as indicated by display block 708.

Also, once the borrower 104 has logged on to the lending service 101, processing can continue to process block 710. In process block 710, the borrower 104 can evaluate an offer 142 from a lender 106. Processing continues to decision block 712 where the borrower 104 can accept or reject the offer 142. If the borrower 104 rejects the offer 142, processing continues back to process block 710 where the borrower can reevaluate the offer 142, for example to present a counteroffer to the lender 106, or evaluate other offers 142 from other lenders 106. If the borrower 104 accepts the offer, processing continues to process block 908, as indicated by off-page reference G.

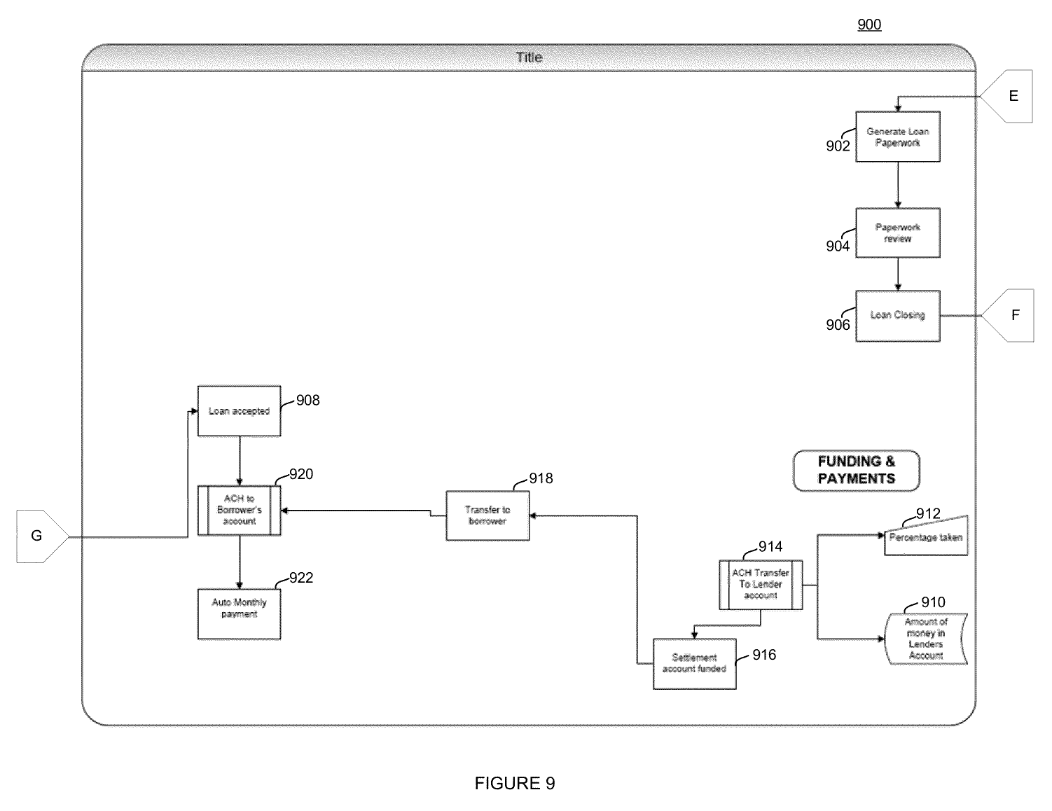

FIG. 9 presents an exemplary flow diagram for title company processes 900 for facilitating lending opportunities between lenders 106 and borrowers 104. In process block 1008, the loan is accepted by the borrower 104. A number of processes can take place either before or after the loan is accepted by the borrower 104 in process block 908, depending upon, for example, when the lender 106 funded the escrow 150 account, and whether the loan closes as described in process block 906 upon the borrower's 104 acceptance in process block 908. For example, in process block 914, an Automatic Clearing House (ACH) transfer request can be used to verify that the lender 106 had sufficient funds in their account to fund the loan, as shown in stored data block 910, and a percentage of the loan can be configured to be paid to the lending service 101 as consideration for providing the lending service 101 to the borrower 104 and lender 106, as illustrated in input block 912. Processing continues to process block 916, where the ACH transfer is used to fund the settlement account. In various configurations, the settlement account can be an account of the lending service 101, a bank 110, or an escrow 150 account controlled by the title company. If the borrower has accepted the loan in process block 908, and if the loan has closed in process block 906, processing continues to process block 918 where the funds are released and available to be transferred to the borrower 104. Processing continues to process block 920 where an ACH transfer is made to the borrower's 104 account. Processing continues to process block 922. In process block 922, the borrower 104 is obligated under the terms of the formal loan agreement 148 to make repayments 154 to the borrower. For example, the repayments can be made by monthly ACH transfers from the borrower's 104 bank 110 to the lender's 106 bank 110.

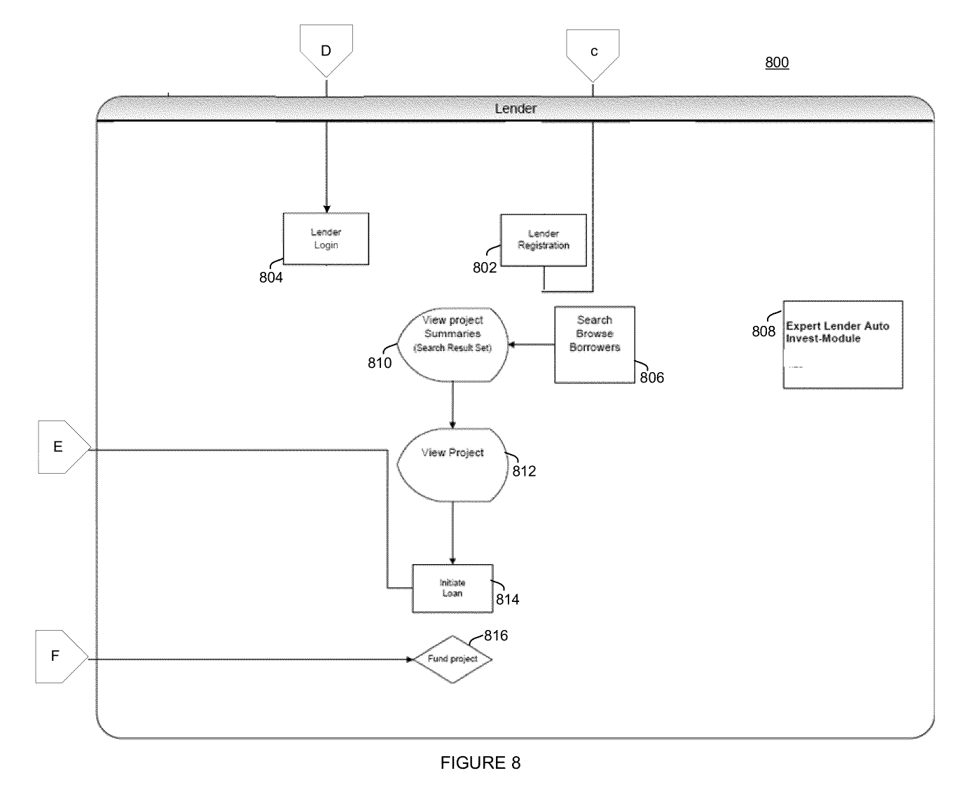

FIG. 8 presents an exemplary flow diagram for a lender dashboard process 800 of the lending service 101 for creating lending opportunities between lenders 106 and borrowers 104. In process block 802, a lender 106 can register to use the lending service 101. The lending service 101 can request information from the lender 106 to qualify the lender 106. For example, the information can include the lender's 106 name, address, company officers, bank account routing information, total amount of money available to lend, and preferences such as the business types, geographic location of businesses of interest, the maximum and minimum amounts of money available to lend to each business, the preferred interest rates to lend the money, and preferred badges 126 that borrowers 104 should have. The registration process can include agreeing to a loan term agreement, site license agreement, an end-user licensing agreements (EULA), a terms of use agreement, loan term agreement that contains the standard terms for loans between borrowers 104 and lenders 106 unless specifically changed by the parties 104, 106, and other kind of license or agreements.

Processing can continue to process block 604 of FIG. 6, as indicated by off-page reference C. In process block 604, the lending service 101 can approve the lender 106 based on the information provided, and other information for example a Dun & Bradstreet® report about the lender 106, reference checks and background checks, including for example a criminal background check of the lender 106. If the lender 106 is rejected, processing terminates at end block 606 and the lender 106 can be informed about the rejection. Otherwise, the lender 106 can be approved, the lender 106 can receive a username and password, and processing can continue to process block 804 of FIG. 8, as indicated by off-page reference D.

In process block 804 of FIG. 8, the lender 106 can log into a home page of the lending service 101 that displays a dashboard of the lender 106. Once the lender 106 has logged on to the lending service 101, processing can continue to process block 806 where the lender 106 can search for listings 136 of borrowers 104, and view the listings 136 as indicated by display block 810, and the project as indicated by display block 812. If the lender 106 wants to further evaluate the borrower 104, listing 136 and project, processing can jump to process block 808 and the lender 106 can utilize an expert system or process to evaluate the opportunity. The expert system or process can include analysis based in part on past loans and lending opportunities, heuristic data about borrowers 104 and lenders 106 and loan repayments 154, etc. Processing can continue to process block 814 where the lender 106 can initiate making a loan offer 142 to the borrower 104. In a configuration, processing can continue to process block 902 of FIG. 9, as indicated by off-page reference E.

In process block 902, the title company 108 can create the formal loan agreement 148 by generating loan paperwork that the parties 104, 106 will sign. Processing continues to process block 904 where the title company 108 and parties 104, 106 review the formal loan agreement 148. The parties 104, 106 agree to the formal loan agreement 148 and sign the formal loan agreement 148. In a configuration, the lender 106 can review and sign the formal loan agreement 148 after making the offer 142 to the borrower 104. This allows the lender 106 to complete the loan process in anticipation of an acceptance 146 from the borrower 104. In a configuration, the borrower 104 can similarly agree in advance to standard terms of the loan and a particular interest rate, so that the offer 142 by the lender 106 can be formalized into the formal loan agreement 148 more quickly after the lender 106 initiates the offer 142. Processing continues to process block 906. In process block 906, the title company 108 performs the loan closing. Processing continues to decision block 816 of FIG. 8, as indicated by off-page reference F.

In various configurations, at process blocks 902, 904, 906, or other process blocks, an additional process of an administrative review and approval of the loan, as illustrated in process block 608 of FIG. 6, can be triggered. For example, for loans meeting threshold dollar amounts, an administrative review may be triggered, while loans of lesser dollar amounts may not trigger the administrative review. The administrative review can be triggered randomly, pseudo-randomly, or based upon a variety of thresholds, trigger events such as a substantial number of loans being approved within a period of time, or other heuristically or analytic methodologies to prevent fraud and prevent accidental funding. In process block 610, an administrator can log in to the lending service 101. Processing continues to process block 612 where the administrator can change borrower 104 or lender 106 passwords, or block borrower 104 or lenders 106 in the event that unusual activity is taking place or upon suspicion of fraud. The administrator can also unblock accounts.

In decision block 816, the funds from the lender 106 can be made available for the project if certain conditions are met. For example, the funds can be released only after the loan is signed by the borrower 104. In another example, if the lender 106 has agreed to the loan in advance of the borrower 104 accepting the loan, the funds can be released by the lender 106 and held in escrow 150 by the title company until the loan is signed by the borrower 104, or returned to the lender 106 if the borrower 104 does not, or cannot, accept the loan. In another example, the loan may close, but the borrower 104 may not have reached certain conditions for the funding to occur, for example the borrower's 104 project may not have reached certain subscription thresholds. In this situation, the title company holds the funds in escrow so that the funds are guaranteed to be available promptly once the borrower's 104 project reaches the threshold subscription levels necessary to release the funds. In another configuration, for qualified lenders 106, the funds are held in the lender's 106 bank 110 until the threshold subscription levels are triggered.

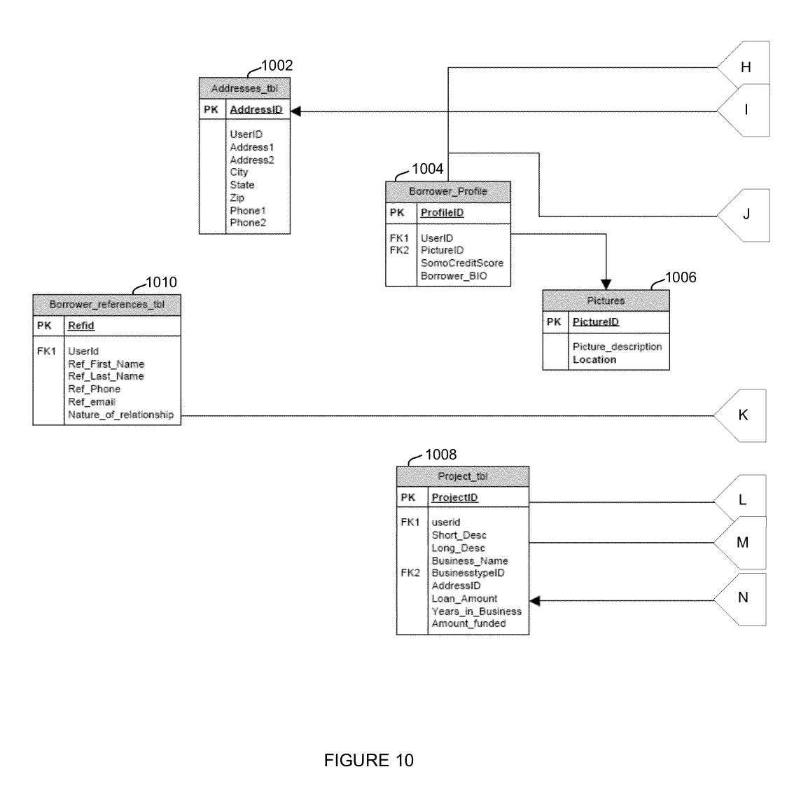

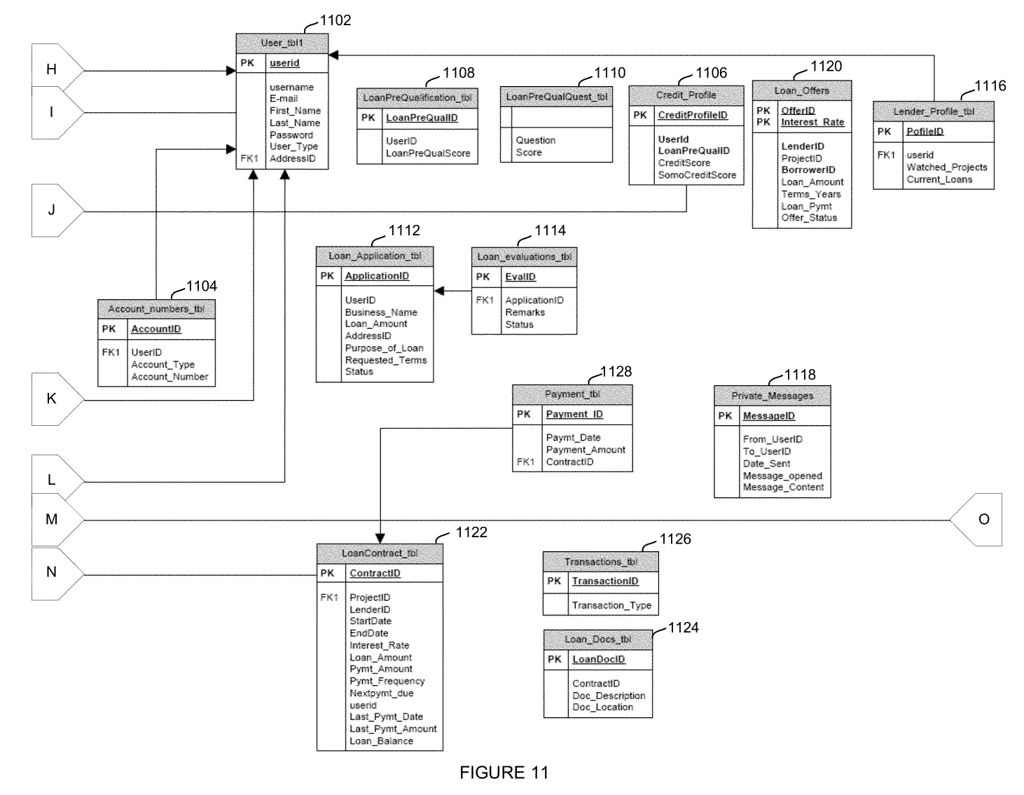

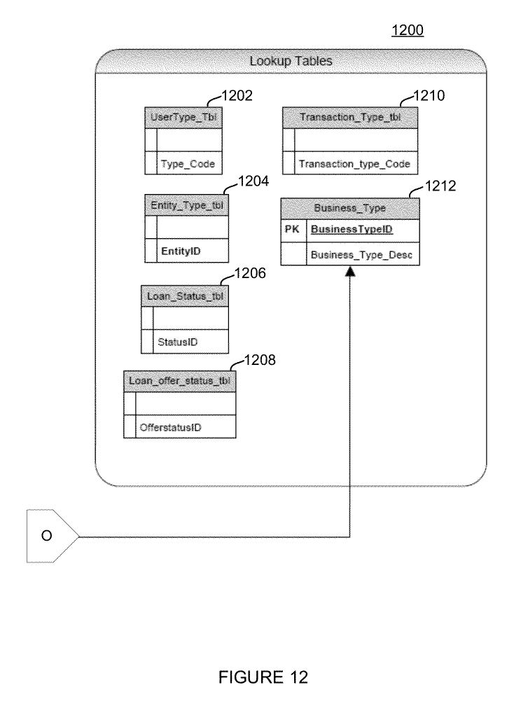

FIGS. 10, 11, and 12 present a schema of data structures used in the above described processes. In this specific example, the data structures are depicted as tables in a relational database structure. Those of ordinary skill in this area will appreciate that other architectures that are generally consistent with this schema can also be used. For example, data objects in an object-oriented database, objects in an object-oriented software data structure, and other suitable data structures used in other architectures can be used in addition to, or instead of, the relational database structure shown these figures and described below. Links between tables and off-page references H, I, J, K, L, M, N, and O are presented to assist the reader with understanding possible relationships between the elements of the tables and data structures, and are not intended to limit the data structures or applications related to the data structures as described in the systems and methods presented in this disclosure.

A database for storing the data structures can include tables linked to other tables, or elements of other tables, using primary keys (PK) and foreign keys (FK). Elements of the table can include unique identifiers, primary keys (PK), foreign keys (FK), links to external data, pointers to data, as well as data fields such as numeric fields, date fields, and text fields.

For example, user information for borrowers 104 and lenders 106 can be stored in a table such as User_tb11 1102 having elements including the PK element userid (a unique identifier used by the lending service 101 for each user.) Other elements of the table can include username (the username for using the lending service 101), E-mail (the email address of the user), First_Name (a first name of the user), Last_Name (the surname of the user), Password (the user's password for using the lending service 101), User_type (for example a borrower 104, lender 106, or administrator), and AddressID (an FK that links to the table Addresses_tb1 1002.)

The table Addresses_tb1 1002 is a table that can store address information about a user. The table Addresses_tb1 1002 can include the PK element AddressID (a unique identifier used by the lending service 101 for each user address.) Other elements can include UserID (an entry in the table User_tb11 1102), Address1 (a first line of a user's mailing address), Address2 (a second line of a user's mailing address), City (the user's city), State (the user's state), Zip (the user's Zip Code), Phone1 (a first phone number of the user), and Phone2 (a second phone number of the user.)

The table Account_number_tb1 1104 can store bank account information for a user. The table Account_number_tb1 1104 can include the PK element AccountID (a unique identifier user by the lending service 101 for each account.) Other elements can include UserID (an FK to an entry in the table User_tb11 1102), Account_Type (for storing information about the account type), and Account_Number (for storing bank routing information and account number.)

Borrower 104 specific information can be stored in tables Borrower_Profile 1004, Pictures 1006, and Project_tb1 1008. The table Borrower_Profile 1004 can include the PK element ProfileID (a unique identifier of the user's profile.) The Borrower_Profile 1004 can also include elements UserID (the FK link to an entry in the table User_tb11 1102), PictureID (the FK linked to the table Pictures), SomoCreditScore (the borrower's 104 computed credit score used by the lending service 101 in grading borrowers 104), and Borrower_BIO (information about the borrower 104.)

Pictures 1006 is a table that can include information about graphical images related to the borrower 104 and the project. The table Pictures can include the PK element PictureID (a unique identifier of the picture.) The table Pictures can also include the elements Picture_description (information about the picture) and Location (a link to the graphical representation or picture, for example a picture stored on a web service, or a Global Positioning System or GPS reference, or similar geographic reference, that enables a street view, aerial view, or other view of the business.)

Project_tb1 1008 is a table that can include information about the borrower's 104 project. The table Project_tb1 1008 can include the PK element ProjectID (a unique identifier of the user's or borrower's 104 project. The table Project_tb1 1008 can also include elements userid (an FK to an entry in the table User_tb11 1102), Short_Desc (a short description of the project, for example a synopsis), Long_Desc (a full description of the project), Business_Name (the name of the business of the borrower 104), BusinesstypeID (a descriptor that can be used by lenders to search for specific kinds of businesses), AddressID (an entry from the table Addresses_tb1 1002 that includes the address of the borrower 104 or business), Loan_Amount (the requested amount of the loan by the borrower 104 for the business), Years_in_Business (the length of time the business has been in business or the year the business was established), Amount_funded (the amount of the loan that has been currently funded.)

Credit_Profile 1106 is a table that can include information about the user's credit worthiness. The table Credit_Profile 1106 can include the PK element CreditProfileID (a unique identifier of the user's or borrower's 104 credit profile.) The table Credit_Profile 1106 can also include the UserID (an entry in the table User_tb11 1102), LoanPreQualID (an entry from the table LoanPreQualification_tb1 1108), CreditScore (a credit rating from an accrediting agency), and SomoCreditScore (the borrower's 104 computed credit score used by the lending service 101 in grading borrowers 104.)

LoanPreQualification_tb1 1108 is a table that can include information used to initially qualify the user for using the lending service 101. The table LoanPreQualification_tb1 1108 can include the PK element LoanPreQualID (a unique identifier used by the lending service 101 to identify a record.) The table LoanPreQualification_tb1 1108 can also include elements UserID (an entry from the table User_tb11 1102), and LoanPreQualScore (the initial qualification score of the user by the lending service 101 that was performed to determine if the user is qualified to use the lending service 101.)

In making the determination as to whether a user is qualified to use the lending service 101, the lending service 101 can utilize multiple questions and perform the determination through analysis of the answers by the user applicant. The scores for each question can be stored as entries in the table LoanPreQualQuest_tb1 1110. The table LoanPreQualQuest_tb1 1110 can include a question (an identifier of the question) and a score (a grade used to make the initial determination as to whether the user can use the lending service 101.

The table Loan_Application_tb1 1112 can include information about a borrower's 104 loan request. The table Loan_Application_tb1 1112 can include the PK element ApplicationID (a unique identifier of the formal loan agreement 148 between a borrower 104 and lender 106.) The table Loan_Application_tb1 1112 can also include elements UserID (one or more entries in the table User_tb11 1102 to identify the lender 106 and possibly the borrower 104, Business_Name (the name of the borrower's 104 business), Loan_Amount (the amount being offered by the lender 106), Purpose_of_Loan (a description of the intended use of the borrowed capital that can include conditions for the borrower 104 or business), Requested_Terms (a description of terms in the formal loan agreement), and status (that can include indications of the status of the loan, for example whether one or both parties 104, 106 have signed the formal loan agreement 148, whether the loan has been reviewed by an administrator, whether the loan has been funded into an escrow account, whether some or all of the capital has been distributed to the borrower 104, and whether the loan has closed.)

A borrower 104 can also have references. Information about the references can be stored in the table Borrower_references_tb1 1010. The table Borrower_references_tb1 1010 can include the PK element Refid (a unique identifier of the borrower's 104 reference.) The table Borrower_references_tb1 1010 can also include the FK element UserId (that references an entry in the table User_tb11 1102), Ref_First_Name (the first name of the borrower's 104 reference), Ref_Last_Name (the last name of the borrower's 104 reference), Ref_Phone (a phone number of the borrower's 104 reference), Ref_email (an email address of the borrower's 104 reference), and Nature_of_relationship (a description of the relationship of the reference to the borrower 104.)

An administrator, for example an administrator of the lending service 101 can review of the formal loan agreement 148 prior to settlement and the loan closing. Information about the review can be stored in the table Loan_evaluations_tb1 1114. The table Loan_evaluations_tb1 1114 can include the PK element EvalID (a unique identifier of the loan evaluation.) The table Loan_evaluations_tb1 1114 can also include elements ApplicationID (an FK to an entry in the table ApplicationID), remarks (an entry of remarks by the administrator or for the administrator's review), and status (for example, whether the administrator approves of the loan application or the loan.)

Lender_Profile_tb1 1116 is a table that can include information about lenders 106. The table Lender_Profile_tb1 1116 can include PK element ProfileID (a unique identifier that correlates to a particular lender 106.) The table Lender_Profile_tb1 1116 can also include elements userid (an entry in the table User_tb11 1102), Watched_Projects (a reference to the projects that the lender 106 is watching or alternatively a reference of searches that the lender 106 is watching), and Current_Loans (a reference to the projects that the lender 106 has funded or is currently funding.)

Lenders 106 can search for lending opportunities by searching records and by searching for elements or fields within records. For example, a lender 106 can search using lookup tables such as UserType_Tb1 1202, that includes the element Type_Code (for searching either borrowers 104 or lenders 106), Entity_Type_tb1 1204, that includes the element EntityID (for searching by userid, Business_Name, ProjectID, LenderID, or BorrowerID), Loan_Status_tb1 1206 that includes the element OfferstatusID (for searching for loans based on status, for example whether a loan has already been approved, or closed an amount with at least one lender 106, or have no lenders 106), Loan_offer_status_tb1 1208 that includes the element OfferStatusID (for searching for projects based on whether a project has an offer, or for searching based on a particular Offer_Status), Transaction_Type_tb1 1210 that includes the element Transaction_type_Code (for searching for projects based on financial transactions such as loan funding for a portion of a project), and Business_Type 1212 that includes the PK element BusinessTypeID (for searching by the type of business or industry) and can include element Business_Type_Desc (for keyword searching projects for particular kinds of business.)

Lenders 106 can communicate with borrowers 104, and borrowers 104 with lenders 106, using communications 140 including an email service provided by the lending service 101. Communications 140 are stored in the table Private_Messages 1118. The table Private_Messages 1118 can include PK element MessageID (a unique identifier that correlates to a particular message sent between the parties 104, 106.) The table Private_Messages 1118 can also include the elements From_UserID (a reference to a userid from the table User_tb11 1102), To_UserID (a reference to a userid from the table User_tb11 1102), Data_Sent (data sent in the message that can include the subject line and other data such as attachments), Message_opened (an indication of whether the receiving party opened the message, for example by reading the message), and Message_Content (the message that can include the message body.)

The lender 106 can extend a loan offer 142 to the borrower 104. The loan offer 142 can be stored in the table Loan_Offers 1120. The table Loan_Offers 1120 can include the PK elements OfferID (a unique identifier of the loan offer 142 from the lender 106 to the borrower 104) and Interest_Rate (the rate of interest for the loan offer 142.) The table Loan_Offers 1120 can also include the LenderID (that identifies the lender 106 for example by userid), ProjectID (an entry in the table Project_tb1 1008 that describes the project being funded), BorrowerID (that identifies the borrower 104, for example by userid), Loan_Amount (the amount being offered by the lender 106), Terms_Years (the loan term, for example the loan term in years), Loan_Pymt (the repayments 154 by the borrower 104 to the lender 106), and the Offer_Status (for example, a loan offer 142, a counteroffer 144, or an acceptance 146).

If the parties 104, 106 agree to the loan with a loan offer 104 and acceptance 146, information about a formal loan agreement 148 can be stored in the table LoanContract_tb1 1122. The table LoanContract_tb1 1122 can include the PK element ContractID (a unique identifier for identifying information about the particular formal loan agreement 148.) The table LoanContract_tb1 1122 can also include the elements ProjectID (an FK associated with an entry in the Project_tb1 1008 table), LenderID (an identifier of the lender, such as a userid), StartDate (the start date for the term of the loan), EndDate (the end date for the term of the loan), Interest_Rate (the rate of interest for the loan), Loan_Amount (the amount being loaned by the lender 106 to the borrower 104), Pymt_Amount (the amount of each repayment 154 by the borrower 104 to the lender 106), Pymt_Frequency (the number of times per year, per month, or per week of the repayments 154), NexPymt_due (the date that the next payment is due by the borrower 104 to the lender 106), userid (the userid of the borrower 104 associated with the business that is being lent the capital), Last_Pymt_Date (the date of the last payment due), Last_Pymt_Amount (the amount of the last payment that can include late fees, balloon payments, or other fees), and LoanBalance (the current amount owed on the loan by the borrower 104 to the lender 106.)

Each repayment 154 can be entered into the table Payment_tb1 1128. The table Payment_tb1 1128 includes the PK element Payment_ID (a unique identifier associated with the repayment 154.) The table Payment_tb1 1128 can include the elements Paymt_Date (the date of the repayment 154), Payment_Amount (the amount of the repayment 154 on that date), and the FK ContractID (an FK associated with an entry in the table LoanContract_tb1 1122.)

Information about the formal loan agreement 148 can be entered into the table Loan_Docs_tb1 1124. The table Loan_Docs_tb1 1124 includes the PK element LoanDocID (a unique identifier associated with the formal loan agreement 148.) The table Loan_Docs_tb1 1124 can include the elements Contract Id. (an entry in the table LoanContract_tb1 1122), Doc_Description (a description of the formal loan agreement 148), Doc_Location (a link to, or description of, the location of the formal loan agreement 148, for example a hyperlink, a computer file directory, a docket number, or other descriptive entry of the location of the formal loan agreement 148.)

Transactions, for example bank transfers through an ACH or automated clearing house, can be included as entries in the table Transactions_tb1 1126. The table Transactions_tb1 1126 includes the PK element TransactionID (a unique identifier of the transfer, credit, debit, payment or other transaction.) The table Transactions_tb1 1126 can include the element Transaction_Type (an indicator of the type of transfer, such as a transfer, credit, debit, payment or other transaction, for example a repayment 154 by a borrower 104 to a lender 106.)

As illustrated in FIGS. 1, 2, and 4 the lending service 101 may provide a borrower 104 with various functionality during the lending process. As is to be appreciated, the functionality provided to a particular borrower may vary based on implementation. Provided below is non-limiting borrower functionality which may be provided in one example configuration.

In a configuration, the borrower 104 can access and create a new profile or edit existing profile. The borrower 104 can also create profiles having varying degrees of detail, such as a general profile and a detailed profile, for example. Some profiles may include attachments of documents while others do not. The borrower 104 can select and set various filters and privacy settings. In a configuration, the borrower 104 can select one or more lender categories to determine which type of lender 106s can view a detailed profile of the borrower 104. Lender categories can include, for example, banks, corporate lenders, and individuals. Some borrowers 104 may indicate that no lenders are permitted to view a detailed profile of the borrower 104. In one configuration, a lender 106 can request to view the detailed profile and authorization must be received from the borrower 104 before the lending service 101 provides the detailed profile to the lender 106. In a configuration, the borrower 104 can select, or otherwise opt into, one or more closed groups, which are described in more detail above. Upon selection of inclusion into a group membership, the borrower 104 can elect to display detailed profiled to all closed group members.

The profile creation can occur at registration, or at any other suitable time throughout the process. Profile creation can include, for example, the supplying of business information, supplying a picture or logo, and uploading various documents. The borrower 104 can also be instructed to select an industry code to be associated with the listing. The industry code can be based on, for example, the North American Industry Classification System (NAICS), or other suitable classification system. The borrower 104 can also supply various tags or keywords associated with their business that can be utilized by the lending service search engine.

The borrower 104 can be assigned a borrower ranking, or other type of borrower scoring metric, upon registration. The ranking may be generated by an underwriting model that uses a variety of factors. The factors may include, for example, and without limitation, management experience, a FICO score, past experience with the lending system (based on badges, for example), social network reputation, and so forth. A weighted input technique may be used, such that certain factors are weighted heavier than others when determining the borrower's ranking.

Once the ranking has been determined, the borrower 104 can be presented with their ranking in any suitable format. For example, the ranking of the borrower 104 may be expressed in terms of stars, points, colors, or any other suitable presentment technique. An expected range of loan parameters based on the scoring model can also be presented to the borrower 104. For example, based on the ranking of the borrower 104, an interest rate range, a length of loan range, and a loan amount cap may be determined. Thus, offers to a borrower 104 from lenders can be restricted based on the parameters associated with the borrower's ranking. By way of example, the lending service 101 may cap a loan to a first borrower having a certain star value to a maximum loan amount of X dollars. The lending service 101 may cap a loan to a second borrower having a higher star value to a maximum loan amount of 2× dollars.

In a configuration, a process is used to verify the borrower 104 following a loan offer. The verification can include, for example, a background check to identify any previous financial felonies, fraud, or other information of interest. Other verification can include, for example, a check of whether the borrower's credit score is within a tolerance of their self-reported score. If the actual credit score is outside a tolerance, the loan may be rejected by the lending service 101.

It is noted that verification can occur at a variety of points in the lending process. For example, verification may be performed after the acceptance by borrower 104 of an offer, at the time of an offer from a lender, or subsequent to acceptance of the offer by prior to the transfer of the funds to the borrower 104.

The lending service 101 can provide the borrower 104 with various emails or other notification throughout the lending process. Notices can include, for example, an account creation notice, a lender availability notice, a loan offer notice, an accepted offer notice, a funds available notice, a fund transfer notice, a payment due date notice, and a past due payment notice.

In a configuration, a lender 106 may request to view of a borrower's detailed profile through an email communication to the borrower, or through other form of electronic request. The borrower 104 may respond to the request and a corresponding notice of the approval or denial may be conveyed to the lender 106 via an electronic notice. Should approval be granted, the detailed profile of the borrower 104 can be provided to the lender 106.

In one configuration, the borrower 104 can accept a loan regardless of the loan amount, even if the loan amount is less than the amount in the borrower's listing. In other configurations, the borrower can only accept a loan if the loan amount exceeds a certain threshold percentage of the amount in the borrower's listing. Moreover, in one configuration, the borrower can adjust loan amount in the listing at any time.

In one configuration, the borrower 104 will not be able to accept a loan offer until all of the funds have been received from the lender 106 by the lending service 101 via ACH. Until the funds are received by the lending service 101, the borrower 104 may be presented with a ‘pending’ loan offer. It is noted that loans do not necessarily need to be aggregated from multiple lenders to the borrower 104. In one configuration, loans are executed between a single borrower account and single lender account.

Upon acceptance of a loan offer, a loan schedule and a promissory note can be automatically generated and presented to the borrower 104 by the lending service 101. An e-signature of the borrower 104 may be captured by the system in conformance with e-signature standards. The promissory note can be prepopulated with information relevant to the loan. The lending service 101 can permit the borrower 104 to access the promissory note, and any other loan agreement information, subsequent to execution. Documents associated with the borrower 104 can include the borrower agreement, terms and conditions, privacy policy, and promissory notes. In some configurations, some or all of the documents used by the lending service 101 for a particular loan can be supplied by the lender 106. In other words, instead of using forms supplied by the lending service 101, lender-specific forms may be utilized. The forms can be provided to the lending service 101 in advance and stored in a database associated with the lending service 101, or can be provided relatively concurrently with the agreement to offer a loan.

In a configuration, a borrower graphical dashboard can show a variety of information, such as existing loans, offers, accepted loans, pending balance and available balance, for example. It is noted that in the event a borrower closes an account, verification and coordination with offers, acceptances and, open loans may be necessary.

As is to be appreciated, the functionality provided to a particular lender may vary based on implementation. Provided below is non-limiting lender functionality which may be provided in one example configuration.

Using the lending service 101, a lender 106 can create a lender profile. Various attributes of the lender 106 may be defined, such as lender preferences, privacy settings, filters, and so forth. A lender 106 can create a closed group. Subsequent to closed group creation, notification of borrowers or other lenders who elect into the closed group can be provided to the lender 106. The lender 106 can also manage the closed group subsequent to creation, such as by management of filters and members associated with the closed group. Using the lending service 101, the lender 106 can also elect into a closed group that was initiated by another user of the lending service 101.

In one configuration, the lender 106 is verified by the lending service 101. The lender 106 may remain classified as an “individual” lender until verified as a financial institution, corporation, or other lending entity.

A lender 106 can view the profiles of various borrowers. In a configuration, the lender does not view the actual ranking (or other generated score) of the borrower. Instead, as described above, the particular terms and conditions associated with the borrower's listing (such as interest rate range, term range, lending cap), can be based on the undisclosed ranking of the borrower.

The view provided to the lender 106 can be based on, for example, a lender's filter, the borrowers profile settings, or other settings. For example, the lender 106 may view borrowers based on the borrower's industry code, geographical location, or other parameters.

A lender 106 may be able to communicate with a particular borrower 104 using any one of a variety of communication techniques. For example, notifications may be sent through a communication internal to the lending service 101 or an email communication may be generated by the lending service 101 and sent to an email address associated with the profile of the borrower 104. Through a communication to the borrower 104, the lender 106 can request access to a detailed profile of the borrower 104.

When a lender 106 wants to make a loan offer to a borrower 104, the lending service 101 can receive the loan parameters from the lender 106, which may include, for example, amount, rate and term. In a configuration, loan offers are not aggregated for a borrower, while in other configurations loan offers may be aggregated per borrower. The loan parameters can be restricted by the lending service 101. As described above, the lending service 101 can provide a range or a cap for various loan parameters, with the range or cap based on the scoring or ranking of the borrower 104. In one configuration, the lender 106 can withdraw the offer prior acceptance by the borrower 104.

Various documents may be produced or stored by the lending service 101 that are relevant to the lender 106, such as lender agreements, terms of use, privacy agreements, agreement to promissory note terms and conditions, e-signature and logs, evidence of agreement, and so forth.

A lender dashboard may be generated, updated, and presented to the lender 106 by the lending service 101. A variety of information may be conveyed by the dashboard, such as offers, acceptances, amounts funded, and amounts available for withdrawal from repayment, for example. The dashboard can also include, for example, repayment Schedules, collections, late/NSF Fees, and so forth.

The functionality provided by the lending service 101 can vary based on implementation. Provided below is non-limiting system functionality which may be provided in one example configuration.

In one configuration, the lending service 101 may execute the underwriting formula or procedure to provide a ranking, score, or other underwriting metric associated with a borrower 104. The lending service 101 can also calculate a repayment schedule based on a loan amount, rate and term. In one configuration, loan payments from a borrower 104 maybe received from an ACH transfer. The lending service 101 may track data, such as lending/transactional fees, interest and principal due, amounts paid, and so forth on a loan-by-loan basis. The lending service 101 may also track various data on a larger scale (such as a system wide scale).

In one configuration, the lending service 101 may log and record the agreement of the lender 106 and the borrower 104 to various terms and conditions. For example, indications of acceptance of user terms and conditions, privacy policies, promissory notes, and the like may be stored in a database or other data store.

Upon acceptance of an offer by a borrower 104, the lending service 101 may trigger a withdrawal from an account associated with the lending service (such as escrow account 151 (FIG. 1)) to a borrower's bank account. During the loan repayment process, the lending service 101 can receive deposits from the borrower's bank account. The lending service 101 can subsequently deposit some or all of the funds received from the borrower into an account associated with the lender 106.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

These and other embodiments of the systems and methods for facilitating the process of facilitating loans between borrowers 104 and lenders 106 utilizing social networking can include other forms of social networking and social media as would be recognized by those skilled in the art. The above descriptions of various systems and methods are intended to illustrate specific examples and describe certain ways of making and using the systems disclosed and described herein. These descriptions are neither intended to be, nor should be taken as, an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

What is claimed is:

1. A computer-based lending method, comprising:
storing, in a database, a plurality of searchable listings, wherein each of the plurality of searchable listings is based on borrower information and project information received from a borrower associated with the searchable listing;
determining, by a computer system in communication with the database, a lending profile for each of the plurality of searchable listings, wherein the lending profile is at least partially based on the borrower information and the project information;
receiving, by the computer system, an inquiry from a lender;
responsive to the inquiry, causing the display of a matched listing to the lender, wherein the matched listing is one of the plurality of searchable listings;
causing the display of, by the computer system, the lending profile of the matched listing;
receiving, by the computer system from the lender, a lending offer for the matched listing; and
receiving, by the computer system from the borrower, an acceptance of the lending offer from the borrower.

2. The computer-based lending method of claim 1, comprising:
receiving electronically transferred funds from the lender; and
responsive to receiving the acceptance of the lending offer from the borrower, causing a transfer of at least a portion of the electronically transferred funds to an account associated with the borrower.

3. The computer-based lending method of claim 1, wherein the borrower information comprises a borrower name, a borrower address, and a borrower credit rating.

4. The computer-based lending method of claim 1, wherein the project information comprises the geographical location of the project, a project type, and a requested loan amount.

5. The computer-based lending method of claim 4, wherein the inquiry from the lender comprises geographical-based inquiry.

6. The computer-based lending method of claim 5, wherein causing the display of a matched listing to the lender comprises causing the display of a matched listing associated with a project having a geographical location matching the geographical-based inquiry.

7. The computer-based lending method of claim 4, wherein the lending offer is for an amount less than the requested loan amount.

8. The computer-based lending method of claim 1, wherein the lending profile comprises a capital lending limit, a maximum loan term and an interest rate range.

9. The computer-based lending method of claim 8, wherein the lending offer comprises a loan amount less than or equal to the capital lending limit, a loan term less than or equal to the maximum loan term, and an interest within the interest rate range.

10. The computer-based lending method of claim 9, comprising:
subsequent to receiving the lending offer, receiving, from the borrower, a lending counteroffer.

11. The computer-based lending method of claim 10, comprising:
subsequent to receiving the lending counteroffer, receiving, from the lender, an acceptance of the lending counteroffer.

12. The computer-based lending method of claim 7, wherein the lending profile comprises a borrower ranking.

13. The computer-based lending method of claim 1, comprising:
issuing, by the computer system, a borrower badge to the borrower, wherein the borrower badge is based on a loan repayment event.

14. The computer-based lending method of claim 1, comprising:
issuing, by the computer system, a lender badge to the lender, wherein the lender badge is based on a lending event.

15. A computer-based lending platform, comprising:
a lending computer system in communication with a database, the lending computer system programmed to:
receive borrower information from a borrower and store the borrower information in the database;
receive project information from the borrower and store the project information in the database;
generate a listing associated with the project information;
receive lender information from a lender;
responsive to a listing search by the lender, determine that the listing is a match to the listing search;
cause the display of listing, the listing comprising a lending profile, the lending profile comprising a capital lending limit, a maximum loan term and an interest rate range, wherein the lending profile is at least partially based on the borrower information and the project information;
receive from the lender a lending offer;
receive from the lender electronically transferred funds from the lender;
receive from the borrower an acceptance of the lending offer; and
responsive to the acceptance of the lending offer, causing the electronic transfer of at least a portion of the electronically transferred funds to a borrower account.

16. The computer-based lending platform of claim 15, wherein at least one of the capital lending limit, a maximum loan term and an interest rate range is changed subsequent to a loan repayment event.

17. The computer-based lending platform of claim 15, wherein the lending computer system is configured to post an informational post related to the listing on a social networking website.

18. A non-transitory computer readable medium storing instructions, that when executed by a processor cause the processor to:
store, in a database, a plurality of searchable listings, wherein each of the plurality of searchable listings is based on information electronically received from a borrower associated with the searchable listing;
determine a lending profile for each of the plurality of searchable listings, wherein the lending profile is at least partially based on the borrower information and the project information;
receive an inquiry from a lender;
responsive to the inquiry, cause the display of a matched listing to the lender, wherein the matched listing is one of the plurality of searchable listings;
cause the display of the lending profile of the matched listing;
receive from the lender a lending offer for the matched listing; and
receive from the borrower an acceptance of the lending offer.

19. The non-transitory computer readable medium of claim 18, further comprising instructions to:
receive electronically transferred funds from the lender;
responsive to receiving by the computer system from the borrower the acceptance of the lending offer, cause the transfer of at least a portion of the electronically transferred funds to a borrower account.

20. The non-transitory computer readable medium of claim 18, further comprising instructions to:
issue a borrower badge to the borrower, wherein the borrower badge is based on a loan repayment event; and
issue a lender badge to the lender, wherein the lender badge is based on a lending event.
